(19) United States
(12) Patent Application Publication
(10) Pub. No.: US 2015/0066941 A1
(43) Pub. Date: Mar. 5, 2015

(54) PHOTO CATALOGING, STORAGE AND RETRIEVAL USING RELATIONSHIPS BETWEEN PEOPLE

(71) Applicant: U-Me Holdings LLC, Carthage, MO (US)

(72) Inventor: Derek P. Martin, Carthage, MO (US)

(73) Assignee: U-Me Holdings LLC, Carthage, MO (US)

(21) Appl. No.: 14/044,843

(22) Filed: Oct. 2, 2013

Related U.S. Application Data
(63) Continuation-in-part of application No. 14/016,038, filed on Aug. 30, 2013.

(51) Int. Cl. G06F 17/30

(52) U.S. Cl. CPC G06F 17/30321
USPC 707/741

(57) ABSTRACT

A computer system includes a photo processing mechanism that allows cataloging and storing a user's photos using relationships between people that allow the user's photos to be retrieved using a search engine. A user enters people and specifies relationships, and may also enter locations, events, and other information. Photos are then processed, and indexing info is generated for each photo that may include any or all of the following: user-defined relationships, system-derived relationships, user-defined locations, system-defined locations, user-defined events, and system-derived events and ages for the people in the photos. The indexing info may be stored as metadata with the photo or may be stored separately from the photo. The indexing info allows photos to be retrieved using a powerful search engine.

### BACKGROUND

1. Technical Field

This disclosure generally relates to computer systems, and more specifically relates to making information relating to a user such as a user's photos available in the cloud.

2. Background Art

Modern technology has greatly simplified many aspects of our lives. For example, the Internet has made vast amounts of information available at the click of a mouse. Smart phones allow not only making phone calls, but also provide a mobile computing platform by providing the ability to run apps, view e-mail, and access many different types of information, including calendar, contacts, etc.

Photography is an area that has greatly benefited from modern technology. Digital cameras and cell phones allow capturing very high-resolution photographs and video in digital form that can be easily stored to an electronic device. While photography itself has been revolutionized by technology, the technology for storing and retrieving photographs has lagged far behind. Many people who have used digital cameras for years have many directories or folders on a computer system that contain thousands of digital photos and videos. When a person uses a digital camera or cell phone to take a photo, the device typically names the photo with a cryptic name that includes a number that is sequential. For example, a Nikon camera may name a photo file with a name such as “DSC_{—}0012.jpg.”. The digital file for the next photo is the next number in sequence, such as DSC_{—}0013.jpg. Once the photo files are transferred to a computer and are deleted on the digital camera or cell phone, the digital camera or cell phone may reuse file names that were used previously. To avoid overwriting existing photos, many users choose to create a new directory or folder each time photos are downloaded from a camera or cell phone. This results in two significant problems. First, the file name for a photo may be shared by multiple photos in multiple directories. Second, the names of digital photo files give the user no information regarding the photo. Thus, to locate a particular photo of interest, the user may have to navigate a large number of directories, searching thumbnails of the photos in each directory to locate the desired photo. This is grossly inefficient and relies on the memory of the user to locate a desired photo. A user can more efficiently locate photos if the user takes the time to carefully name directories or folders and also takes the time to carefully name individual photo files. But this is very time-consuming, and most users don't take the time needed to name folders and photo files in a way that would make retrieval of the photos easier. Most people who take digital photos have thousands of photos that have cryptic names in dozens or hundreds of different directories or folders that may also have cryptic names. The result is that finding a particular photo may be very difficult.

While there are programs that allow organizing digital photos, they have not gained widespread acceptance due to their expense and the time required and difficulty for a user to organize their photos using these programs. As a result, these programs have done little to address the widespread problem of most users having thousands of digital photos that are stored using cryptic names in many different directories or folders, making retrieval of photographs difficult. The prior art includes various programs and online services that support photo tagging. Photo tagging is a way to add tags, or identifiers, to the metadata in a photo. Thus, a person could tag a photo with the names of people in the photo. Google's Picasa service includes face recognition and tagging. Thus, the face recognition engine in Picasa can recognize a person's face in multiple photos, and can then create a tag for that person that is written to the metadata for each of the photos. This allows for more easily retrieving photos based on a search of tags. However, current tagging technology is not very sophisticated. If a person tags some photos with the name Jim, and other photos with the name Jimmy for the same person, a search for Jim will identify the photos tagged with Jim but will not identify the photos tagged with Jimmy. Known tagging allows placing simple labels in the metadata of a photo file. A person can then use a search engine to search for photos that have one or more specified tags. But current tags do not allow identifying relationships between people, do not allow storing ages of people, and lack the flexibility and power needed to catalog, store and retrieve photos in a powerful way.

### BRIEF SUMMARY

A computer system includes a photo processing mechanism that allows cataloging and storing a user's photos using relationships between people that allow the user's photos to be retrieved using a search engine. A user enters people and specifies relationships, and may also enter locations, events, and other information. Photos are then processed, and indexing info is generated for each photo that may include any or all of the following: user-defined relationships, system-derived relationships, user-defined locations, system-defined locations, user-defined events, and system-derived events and ages for the people in the photos. The indexing info is used to catalog a photo for easy retrieval later. The indexing info may be stored as metadata with the photo or may be stored separately from the photo. The indexing info allows photos to be retrieved using a powerful search engine.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram showing the Universal Me (U-Me) system;

FIG. 2 is a block diagram showing additional details of the U-Me system;

FIG. 3 is a block diagram showing a computer system that runs the U-Me system;

FIG. 4 is a block diagram showing how a user using a physical device can access information in the U-Me system;

FIG. 5 is a block diagram showing various features of the U-Me system;

FIG. 6 is a block diagram showing examples of user data;

FIG. 7 is a block diagram showing examples of user licensed content;

FIG. 8 is a block diagram showing examples of user settings;

FIG. 9 is a block diagram showing examples of universal templates;

FIG. 10 is a block diagram showing examples of device-specific templates;

FIG. 11 is a block diagram showing examples of device interfaces;

FIG. 12 is a block diagram of a universal user interface;

FIG. 13 is a flow diagram of a method for generating indexing info for one or more photos;

FIG. 14 is a data entry screen for entering info about people into the U-Me system;

FIG. 15 shows the data entry screen in FIG. 14 after a person fills in information;

FIG. 16 is a data entry screen for a person to enter family relationships;

FIG. 17 shows the data entry screen in FIG. 16 after a person fills in information regarding family relationships;

FIG. 18 is a block diagram showing different entries for a spouse and a wedding date to the spouse;

FIG. 19 is a block diagram showing user-defined relationships and system-derived relationships that are derived from the user-defined relationships;

FIG. 20 is a flow diagram of a method for constructing relationships based on the photo system data entry;

FIG. 21 is a display of a family tree based on the information entered by a user in the data entry screen in FIG. 17;

FIG. 22 is a block diagram showing the user-defined relationships entered by a user in the data entry screen in FIG. 17;

FIG. 23 is a display of the family tree in FIG. 21 after adding information relating to the wife and son of Billy Jones;

FIG. 24 is a block diagram showing both the user-defined relationships as well as the system-derived relationships for the family tree in FIG. 23;

FIG. 25 is a data entry screen for a person to enter locations;

FIG. 26 shows a data entry screen that allows a person to define a location based on an address;

FIG. 27 is a flow diagram of a method for defining a location using an app on a mobile device;

FIG. 28 is a schematic diagram showing how method 2700 in FIG. 27 could be used for a user to define two different geographic regions that are stored as locations;

FIG. 29 is a block diagram showing user-defined locations and system-defined locations;

FIG. 30 shows examples of photo metadata;

FIG. 31 is a flow diagram of a method for adding location name to indexing information for a photo;

FIG. 32 is a block diagram showing photo indexing info that could be generated for a photo;

FIG. 33 is a block diagram showing examples of markup language tags that could be used as photo indexing info;

FIG. 34 is a block diagram showing examples of user-defined events, system-derived events, and system-defined events selected by a user;

FIG. 35 is a flow diagram of a method for generating and storing indexing info for a photo;

FIG. 36 is a flow diagram of a method for processing a photo for facial and feature recognition;

FIG. 37 is a flow diagram of a method for generating indexing info for a photo;

FIG. 38 is a flow diagram of a method for generating indexing information relating to one or more locations(s) for a photo when a user defines a location for the photo;

FIG. 39 is a flow diagram of a method for generating indexing information relating to one or more locations(s) for a photo based on geocode info in the photo metadata;

FIG. 40 is a flow diagram of a method for generating indexing information relating to one or more events for a photo based on a date or date range for the photo;

FIG. 41 is a flow diagram of a method for generating indexing information for a photographer's name based on the camera that took the photo;

FIG. 42 is a flow diagram of a method for automatically processing a photo using the U-Me system;

FIG. 43 is a flow diagram of a method for storing photos that were scanned from hard copy photos with corresponding indexing information;

FIG. 44 is a flow diagram of a method for a user to define indexing info for one or more photos at the same time;

FIG. 45 shows storing indexing info separate from a digital photo file;

FIG. 46 shows storing the indexing info within the digital photo file;

FIG. 47 is an example of a data entry screen for a user to generate indexing info for one or more photos as shown in the method in FIG. 44;

FIG. 48 shows a screen for an example of a photo search engine;

FIG. 49 shows examples of photo queries that could be formulated in the photo search engine shown in FIG. 48;

FIG. 50 shows a screen for an example photo share engine;

FIG. 51 is a flow diagram of a method for sharing photos in a user's U-Me account with another user;

FIG. 52 is a representation of a sample photo;

FIG. 53 is sample indexing info that could be generated for the sample photo in FIG. 52;

FIG. 54 shows information in a user's U-Me account;

FIG. 55 represents how a first user's people info, location info, and event info can be shared with a second user, and further shows the second user may have different names that correspond to the faces defined in the first user's account, and may have different indexing info for the photos in the first user's account;

FIG. 56 is a method for generating indexing info based on existing tags in a digital photo file;

FIG. 57 is a flow diagram of a method for identifying duplicate photos;

FIG. 58 is a flow diagram of a method for importing people and relationships from an external file; and

FIG. 59 is a flow diagram of a method for automatically propagating changes to a user's U-Me account to indexing info for the user's photos.

### DETAILED DESCRIPTION

The disclosure herein presents a paradigm shift, from the device-centric world we live in today, to a person-centric world. This shift gives rise to many different opportunities that are not available in the world we live in today. A system called Universal Me (U-Me) disclosed herein is a cloud-based system that is person-centric. The U-Me system makes a user's data, licensed content and settings available in the cloud to any suitable device that user may choose to use.

The U-Me system includes a photo processing mechanism that allows cataloging and storing a user's photos using relationships between people that allow the user's photos to be retrieved using a search engine. A user enters people and specifies relationships, and may also enter locations, events, and other information. Photos are then processed, and indexing info is generated for each photo that may include any or all of the following: user-defined relationships, system-derived relationships, user-defined locations, system-defined locations, user-defined events, and system-derived events and ages for the people in the photos. The indexing info is used to catalog a photo for easy retrieval later. The indexing info may be stored as metadata with the photo or may be stored separately from the photo. The indexing info allows photos to be retrieved using a powerful search engine.

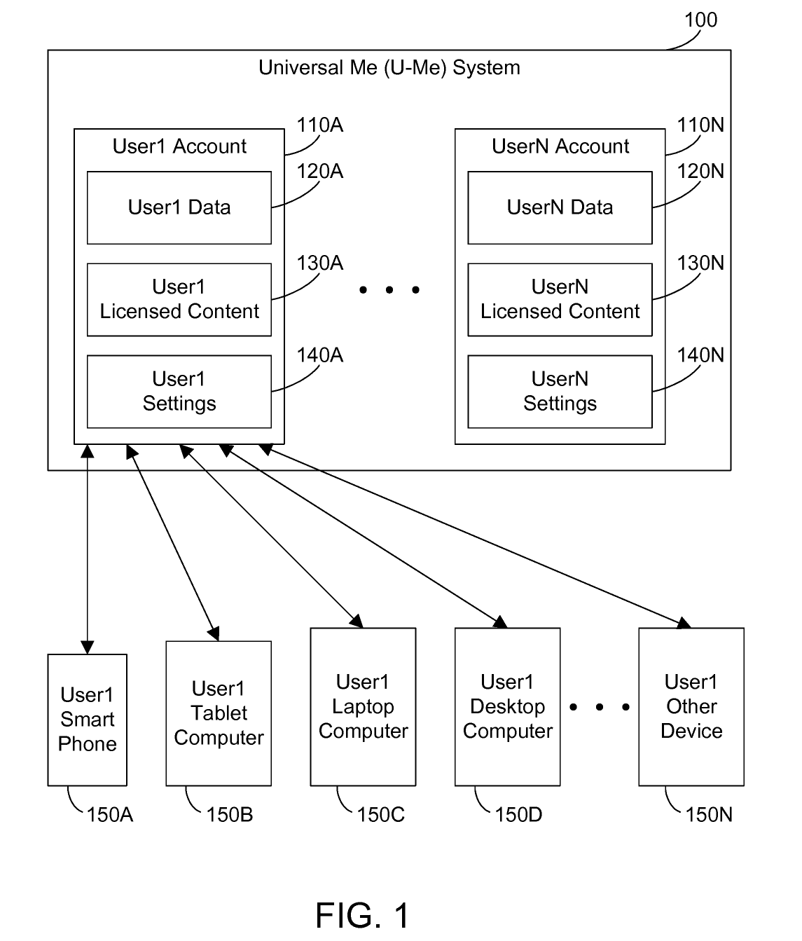

Referring to FIG. 1, the Universal Me (U-Me) system 100 includes multiple user accounts 110, shown in FIG. 1 as 110A, . . . , 110N. Each user account includes data, licensed content, and settings that correspond to the user. Thus, User1 account 110A includes corresponding data 120A, licensed content 130A, and settings 140A. In similar fashion, UserN account 110N includes corresponding data 120N, licensed content 130N, and settings 140N. Any or all of the user's data, licensed content and settings may be made available on any device 150 the user may use. Examples of suitable devices are shown in FIG. 1 to include a smart phone 150A, a tablet computer 150B, a laptop computer 150C, a desktop computer 150D, and other device 150N. The devices shown in FIG. 1 are examples of suitable devices the user could use to access any of the data, licensed content, or settings in the user's account. The disclosure and claims herein expressly extend to using any type of device to access the user's data, licensed content, or settings, whether the device is currently known or developed in the future.

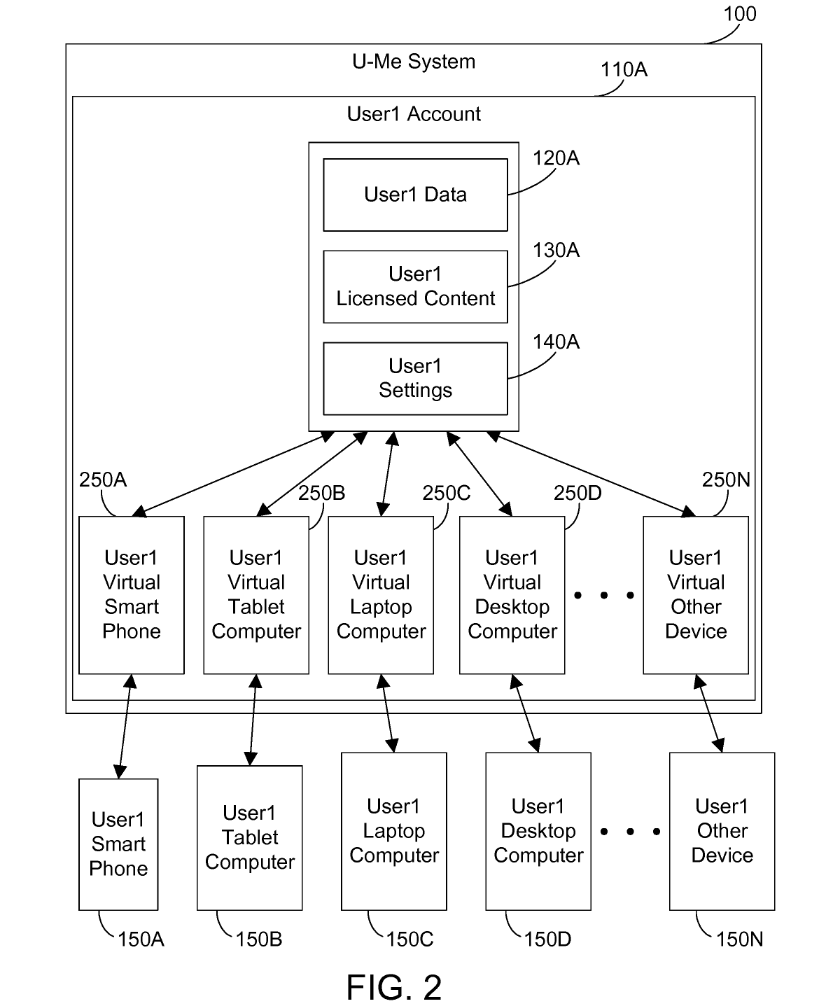

The U-Me system 100 may include virtual devices in a user's account. Referring to FIG. 2, the User1 account 110A is shown to include a virtual smart phone 250A that corresponds to the physical smart phone 150A; a virtual tablet computer 250B that corresponds to the physical tablet computer 150B; a virtual laptop computer 250C that corresponds to the physical laptop computer 150C; a virtual desktop computer 250D that corresponds to a physical desktop computer 150D; and a virtual other device 250N that corresponds to a physical other device 150N. The virtual devices preferably include all information that makes a physical device function, including operating system software and settings, software applications (including apps) and their settings, and user settings. It may be impossible due to access limitations on the physical device to copy all the information that makes the physical device function. For example, the operating system may not allow for the operating system code to be copied. The virtual devices contain as much information as they are allowed to contain by the physical devices. In the most preferred implementation, the virtual devices contain all information that makes the physical devices function. In this scenario, if a user accidentally flushes his smart phone down the toilet, the user can purchase a new smart phone, and all the needed information to configure the new smart phone exactly as the old one is available in the virtual smart phone stored in the user's U-Me account. Once the user downloads a U-Me app on the new smart phone, the phone will connect to the user's U-Me account, authenticate the user, and the user will then have the option of configuring the new device exactly as the old device was configured using the information in the virtual smart phone in the user's U-Me account.

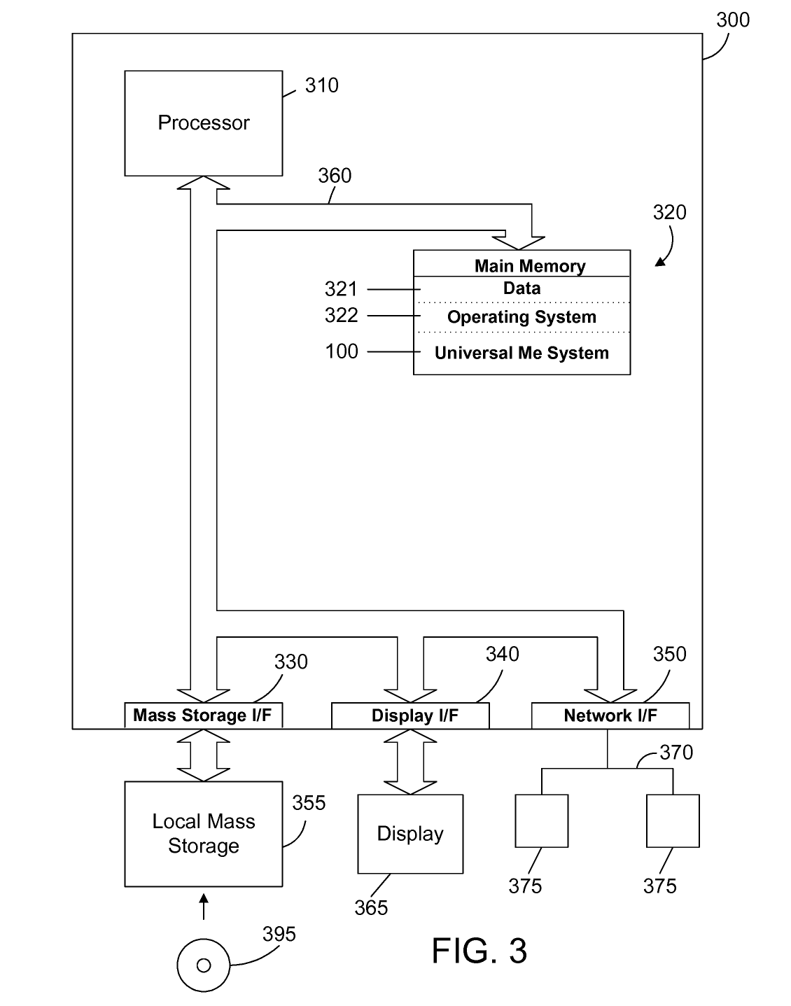

FIG. 2 in conjunction with FIGS. 3, 5 and 13 supports a computer-implemented method executing on at least one processor comprising: defining information for a plurality of people including at least one user-defined relationship between the plurality of people; deriving at least one system-derived relationship between the plurality of people that is derived from the at least one user-defined relationship; and generating indexing information for a digital photo file that includes at least one of the at least one user-defined relationship and the at least one system-derived relationship.

There may be some software on a physical device that cannot be copied to the corresponding virtual device. When this is the case, the U-Me account will prompt the user with a list of things to do before the new physical device can be configured using the data in the virtual device. For example, if the user had just applied an operating system update and the new phone did not include that update, the user will be prompted to update the operating system before continuing. If an app installed on the old phone cannot be copied to the user's U-Me account, the U-Me app could prompt the user to install the app before the rest of the phone can be configured. The virtual device preferably contains as much information as possible for configuring the new device, but when information is missing, the U-Me system prompts the user to perform certain tasks as prerequisites. Once the tasks have been performed by the user, the U-Me system can take over and configure the phone using the information stored in the corresponding virtual device.

Referring to FIG. 3, a computer system 300 is an example of one suitable computer system that could host the universal me system 100. Server computer system 300 is an IBM System i computer system. However, those skilled in the art will appreciate that the disclosure and claims herein apply equally to any computer system, regardless of whether the computer system is a complicated multi-user computing apparatus, a single user workstation, or an embedded control system. As shown in FIG. 3, computer system 300 comprises one or more processors 310, a main memory 320, a mass storage interface 330, a display interface 340, and a network interface 350. These system components are interconnected through the use of a system bus 360. Mass storage interface 330 is used to connect mass storage devices, such as local mass storage device 355, to computer system 300. One specific type of local mass storage device 355 is a readable and writable CD-RW drive, which may store data to and read data from a CD-RW 395.

Main memory 320 preferably contains data 321, an operating system 322, and the Universal Me System 100. Data 121 represents any data that serves as input to or output from any program in computer system 100. Operating system 322 is a multitasking operating system. The Universal Me System 100 is the cloud-based system described in detail in this specification. The Universal Me System 100 as shown in FIG. 3 is a software mechanism that provides all of the functionality of the U-Me system.

FIG. 3 in conjunction with FIGS. 1, 5 and 13 thus shows a computer system comprising: at least one processor; a memory coupled to the at least one processor; information for a plurality of people including at least one user-defined relationship between the plurality of people; at least one system-derived relationship between the plurality of people that is derived from the at least one user-defined relationship; and a photo mechanism residing in the memory and executed by the at least one processor, the photo mechanism generating indexing information for a digital photo file that includes at least one of the at least one user-defined relationship and the at least one system-derived relationship.

Computer system 300 utilizes well known virtual addressing mechanisms that allow the programs of computer system 300 to behave as if they only have access to a large, contiguous address space instead of access to multiple, smaller storage entities such as main memory 320 and local mass storage device 355. Therefore, while data 321, operating system 322, and Universal Me System 100 are shown to reside in main memory 320, those skilled in the art will recognize that these items are not necessarily all completely contained in main memory 320 at the same time. It should also be noted that the term “memory” is used herein generically to refer to the entire virtual memory of computer system 300, and may include the virtual memory of other computer systems coupled to computer system 300.

Processor 310 may be constructed from one or more microprocessors and/or integrated circuits. Processor 310 executes program instructions stored in main memory 320. Main memory 320 stores programs and data that processor 310 may access. When computer system 300 starts up, processor 310 initially executes the program instructions that make up the operating system 322. Processor 310 also executes the Universal Me System 100.

Although computer system 300 is shown to contain only a single processor and a single system bus, those skilled in the art will appreciate that the universal me system may be practiced using a computer system that has multiple processors and/or multiple buses. In addition, the interfaces that are used preferably each include separate, fully programmed microprocessors that are used to off-load compute-intensive processing from processor 310. However, those skilled in the art will appreciate that these functions may be performed using I/O adapters as well.

Display interface 340 is used to directly connect one or more displays 365 to computer system 300. These displays 365, which may be non-intelligent (i.e., dumb) terminals or fully programmable workstations, are used to provide system administrators and users the ability to communicate with computer system 300. Note, however, that while display interface 340 is provided to support communication with one or more displays 365, computer system 300 does not necessarily require a display 365, because all needed interaction with users and other processes may occur via network interface 350.

Network interface 350 is used to connect computer system 300 to other computer systems or workstations 375 via network 370. Network interface 350 broadly represents any suitable way to interconnect electronic devices, regardless of whether the network 370 comprises present-day analog and/or digital techniques or via some networking mechanism of the future. Network interface 350 preferably includes a combination of hardware and software that allow communicating on the network 370. Software in the network interface 350 preferably includes a communication manager that manages communication with other computer systems 375 via network 370 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 350.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

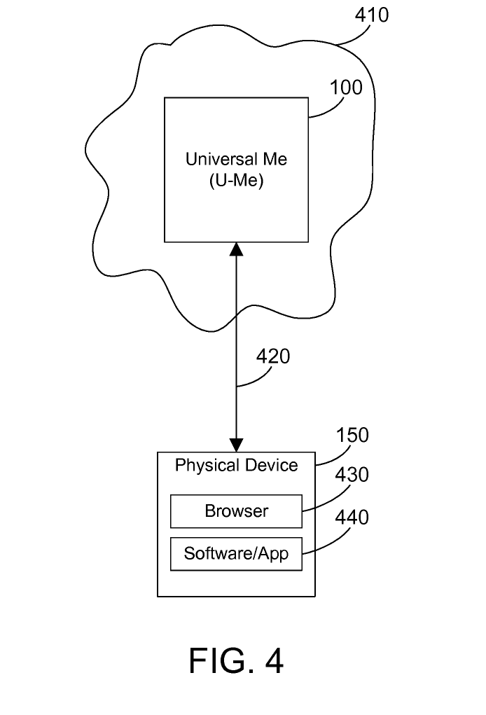

FIG. 4 shows another view of a configuration for running the U-Me system 100. The U-Me system 100 preferably runs in a cloud, shown in FIG. 4 as cloud 410. A user connects to the U-Me system 100 using some physical device 150 that may include a browser 430 and/or software 440 (such as an application or app) that allows the user to interact with the U-Me system 100. Note the physical device 150 is connected to the U-Me system 100 by a network connection 420, which is representative of network 370 shown in FIG. 3, and which can include any suitable wired or wireless network or combination of networks. The network connection 420 in the most preferred implementation is an Internet connection, which makes the U-Me system available to any physical device that has Internet access. Note, however, other types of networks may be used, such as satellite networks and wireless networks. The disclosure and claims herein expressly extend to any suitable network or connection for connecting a physical device to the U-Me system 100.

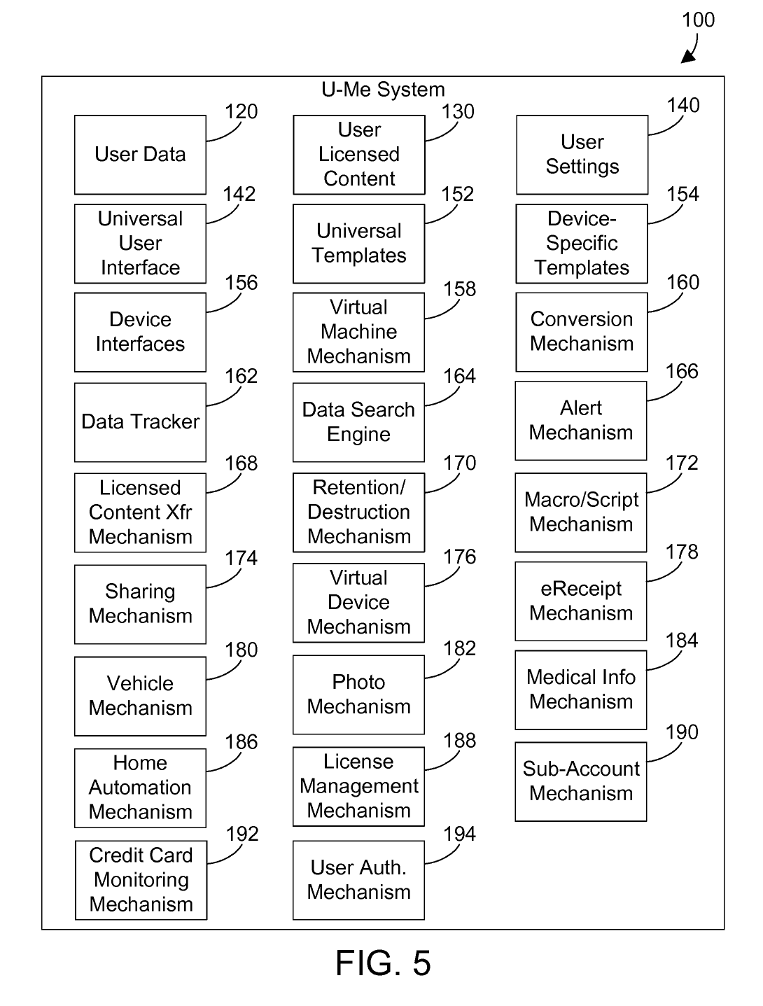

Various features of the U-Me system are represented in FIG. 5. U-Me system 100 includes user data 120, user licensed content 130, and user settings 140, as the specific examples in FIGS. 1 and 2 illustrate. U-Me system 100 further includes a universal user interface 142, universal templates 152, device-specific templates 154, device interfaces 156, a virtual machine mechanism 158, a conversion mechanism 160, a data tracker 162, a data search engine 164, an alert mechanism 166, a licensed content transfer mechanism 168, a retention/destruction mechanism 170, a macro/script mechanism 172, a sharing mechanism 174, a virtual device mechanism 176, an eReceipt mechanism 178, a vehicle mechanism 180, a photo mechanism 182, a medical info mechanism 184, a home automation mechanism 186, a license management mechanism 188, a sub-account mechanism 190, a credit card monitoring mechanism 192, and a user authentication mechanism 194. Each of these features is discussed in more detail below. The virtual devices 150 in FIG. 2 are preferably created and maintained by the virtual device mechanism 176 in FIG. 5. While some of the features represented in FIG. 5 are discussed in detail herein, the details of others are disclosed in the parent application.

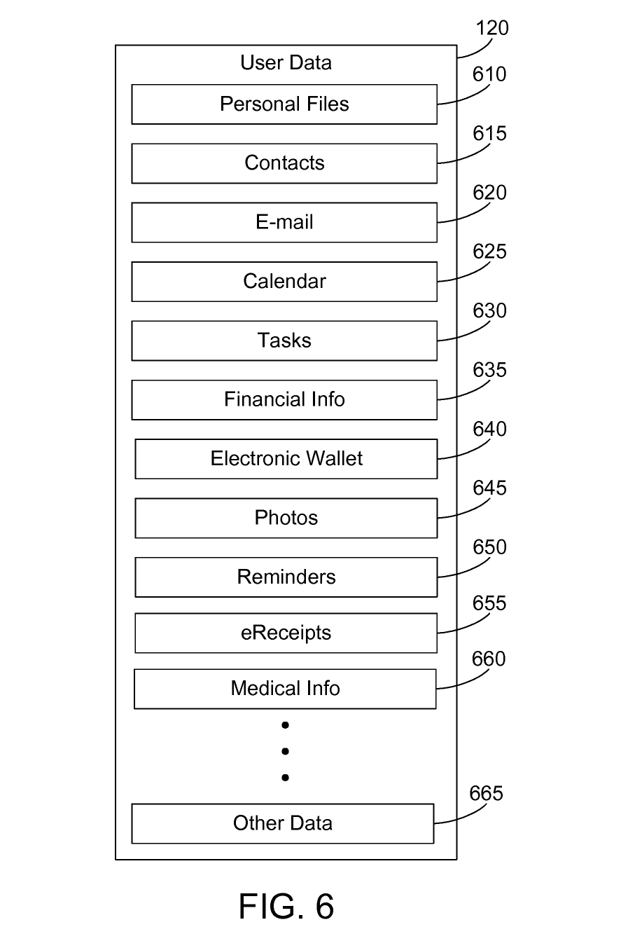

FIG. 6 shows some specific examples of user data 120 that could be stored in a user's U-Me account, including personal files 610, contacts 615, e-mail 620, calendar 625, tasks 630, financial info 635, an electronic wallet 640, photos 645, reminders 650, eReceipts 655, medical information 660, and other data 665. The user data shown in FIG. 6 are examples shown for the purpose of illustration. The disclosure and claims herein extend to any suitable data that can be generated by a user, generated for a user, or any other data relating in any way to the user, including data known today as well as data developed in the future.

Personal files 610 can include any files generated by the user, including word processor files, spreadsheet files, .pdf files, e-mail attachments, etc. Contacts 615 include information for a user's contacts, preferably including name, address, phone number(s), e-mail address, etc. E-mail 620 is e-mail for the user. E-mail 620 may include e-mail from a single e-mail account, or e-mail from multiple e-mail accounts. E-mail 620 may aggregate e-mails from different sources, or may separate e-mails from different sources into different categories or views. Calendar 625 includes an electronic calendar in any suitable form and format. Tasks 630 include tasks that a user may set and tasks set by the U-Me system. Financial info 635 can include any financial information relating to the user, including bank statements, tax returns, investment account information, etc. Electronic wallet 640 includes information for making electronic payments, including credit card and bank account information for the user. Google has a product for Android devices called Google Wallet. The electronic wallet 640 can include the features of known products such as Google Wallet, as well as other features not known in the art.

Photos 645 include digital electronic files for photographs and videos. While it is understood that a user may have videos that are separate from photographs, the term “photos” as used herein includes both photographs and videos for the sake of convenience in discussing the function of the U-Me system. Reminders 650 include any suitable reminders for the user, including reminders for events on the calendar 625, reminders for tasks 630, and reminders set by the U-Me system for other items or events. eReceipts 655 includes electronic receipts in the form of electronic files that may include warranty information and/or links that allow a user to make a warranty claim. Medical info 660 includes any suitable medical information relating to the user, including semi-private medical information, private medical information, and information provided by medical service providers, insurance companies, etc. Other data 665 can include any other suitable data for the user.

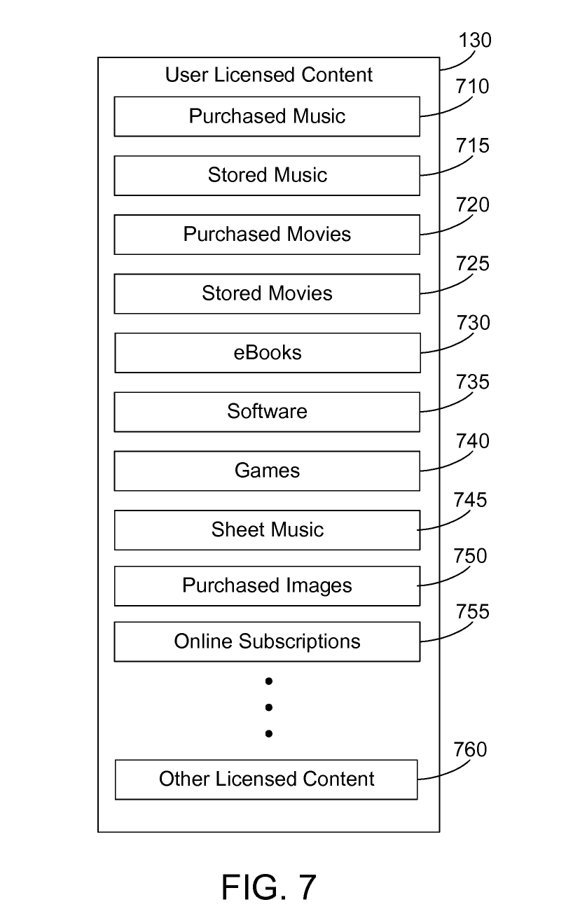

FIG. 7 shows some specific examples of user licensed content 130 that could be stored in a user's U-Me account, including purchased music 710, stored music 715, purchased movies 720, stored movies 725, eBooks 730, software 735, games 740, sheet music 745, purchased images 750, online subscriptions 755, and other licensed content 760. The user licensed content shown in FIG. 7 are examples shown for the purpose of illustration. The disclosure and claims herein extend to any suitable user licensed content, including user licensed content known today as well as user licensed content developed in the future.

Purchased music 710 includes music purchased from an online source. Note the purchased music 710 could include entire music files, or could include license information that authorizes the user to stream a music file on-demand. Stored music 715 includes music the user owns and which has been put into electronic format, such as music recorded (i.e., ripped) from a compact disc. Purchased movies 720 include movies purchased from an online source. Note the purchased movies 720 could include an entire movie file, or could include license information that authorizes the user to stream a movie on-demand. Stored movies 725 include movies the user owns and which have been put into electronic format, such as movies recorded from a digital video disc (DVD). eBooks 730 include books for the Apple iPad, books for the Kindle Fire, and books for the Barnes & Noble Nook. Of course, eBooks 730 could include books in any suitable electronic format.

Software 735 includes software licensed to the user and/or to the user's devices. In the most preferred implementation, software is licensed to the user and not to any particular device, which makes the software available to the user on any device capable of running the software. However, software 735 may also include software licensed to a user for use on only one device, as discussed in more detail below. Software 735 may include operating system software, software applications, apps, or any other software capable of running on any device. In addition, software 735 may include a backup of all software stored on all devices used by the user. Games 740 include any suitable electronic games, including games for computer systems and any suitable gaming system. Known gaming systems include Sony Playstation, Microsoft Xbox, Nintendo Wii, and others. Games 740 may include any games for any platform, whether currently known or developed in the future. Sheet music 745 includes sheet music that has been purchased by a user and is in electronic form. This may include sheet music files that are downloaded as well as hard copy sheet music that has been scanned. Some pianos now include an electronic display screen that is capable of displaying documents such as sheet music files. If a user owns such a piano, the user could access via the piano all of the user's stored sheet music 745 in the user's U-Me account. Purchased images 750 include any images purchased by the user, including clip art, pictures, etc. Online subscriptions 755 include content generated by the user on a subscription basis by any suitable provider. For example, if a user subscribes to Time magazine online, the online subscriptions 755 could include electronic copies of Time magazine. Other licensed content 760 can include any other licensed content for a user.

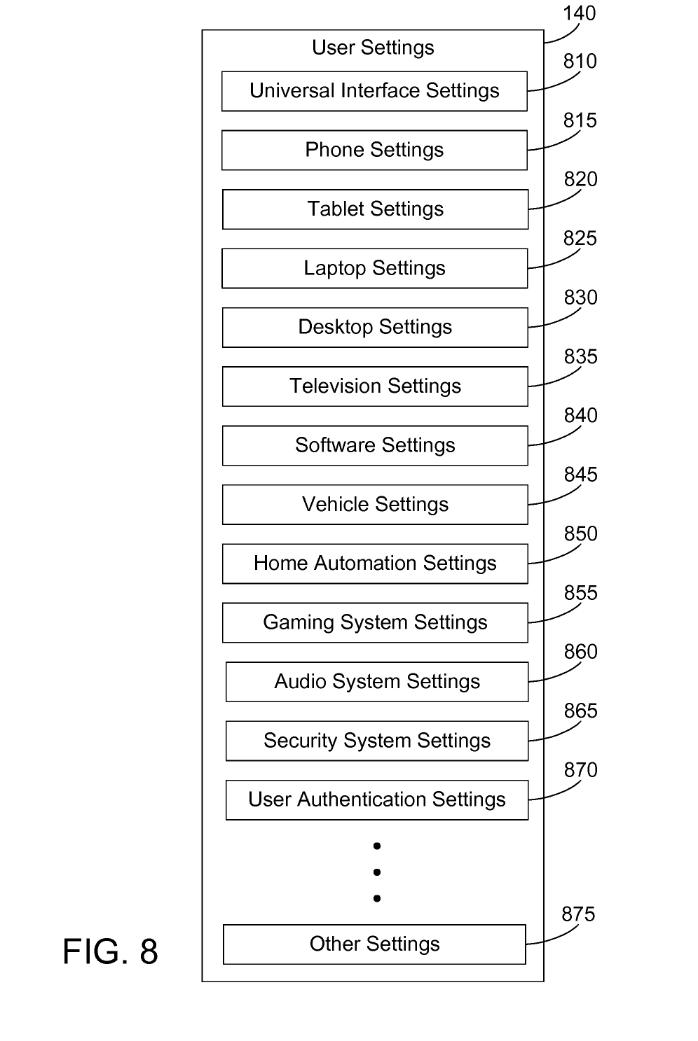

FIG. 8 shows some specific examples of user settings 140 that could be stored in a user's U-Me account, including universal interface settings 810, phone settings 815, tablet settings 820, laptop settings 825, desktop settings 830, television settings 835, software settings 840, vehicle settings 845, home automation settings 850, gaming system settings 855, audio system settings 860, security system settings 865, user authentication settings 870, and other settings 875. The user settings shown in FIG. 8 are examples shown for the purpose of illustration. The software settings 840, which include user settings for software applications, include user preferences for each software application. Note the term “software application” is used herein to broadly encompass any software the user can use, whether it is operating system software, an application for a desktop, an app for a phone, or any other type of software. User settings for physical devices include user settings for each physical device. The term “physical device” is used herein to broadly include any tangible device, whether currently known or developed in the future, that includes any combination of hardware and software. The disclosure and claims herein extend to any suitable user settings, including user settings known today as well as user settings developed in the future.

Universal interface settings 810 include settings for a universal interface for the U-Me system that can be presented to a user on any suitable device, which allows the user to interact with the U-Me system using that device. Phone settings 815 include settings for the user's phone, such as a smart phone. Apple iPhone and Samsung Galaxy S4 are examples of known smart phones. Tablet settings 820 include settings for the user's tablet computer. Examples of known tablet computers include the Apple iPad, Amazon Kindle, Barnes & Noble Nook, Samsung Galaxy Tab, and many others. Laptop settings 825 are settings for a laptop computer. Desktop settings 830 are settings for a desktop computer. Television settings 835 are settings for any suitable television device. For example, television settings 835 could include settings for a television, for a cable set-top box, for a satellite digital video recorder (DVR), for a remote control, and for many other television devices. Software settings 840 include settings specific to software used by the user. Examples of software settings include the configuration of a customizable menu bar on a graphics program such as Microsoft Visio; bookmarks in Google Chrome or favorites in Internet Explorer; default file directory for a word processor such as Microsoft Word; etc. Software settings 840 may include any suitable settings for software that may be defined or configured by a user.

Vehicle settings 845 include user settings relating to a vehicle, including such things as position of seats, position of mirrors, position of the steering wheel, radio presets, heat/cool settings, music playlists, and video playlists. Home automation settings 850 include settings for a home automation system, and may include settings for appliances, heating/ventilation/air conditioning (HVAC), lights, security, home theater, etc. Gaming system settings 855 include settings relating to any gaming system. Audio system settings 860 include settings for any suitable audio system, including a vehicle audio system, a home theater system, a handheld audio player, etc. The security system settings 865 may include settings for any suitable security system. User authentication settings 870 include settings related to the user's authentication to the U-Me system. Other settings 875 may include any other settings for the user.

The U-Me system makes a user's data, licensed content, and settings available to the user on any device the user desires to use. This is a significant advantage for many reasons. First of all, even for people who are comfortable with technology, getting a device configured exactly as the user wants is time-consuming and often requires research to figure out how to configure the device. For example, let's assume a user installs the Google Chrome browser on a desktop computer. When the user downloads a file using Google Chrome, the downloaded file appears as a clickable icon on the lower left of the Google Chrome display. To open the file, the user clicks on the icon. Let's assume the user wants to always open .pdf files after they are downloaded. Because the user does not know how to configure Chrome to do this, the user does a quick search, and discovers that Chrome can be configured to always open .pdf files after they are downloaded by clicking on a down arrow next to the downloaded .pdf file icon, which brings up a pop-up menu, then selecting “Always open files of this type.” This configures Google Chrome to always open .pdf files after they are downloaded. However, the user cannot be expected to remember this small tidbit of knowledge. If the user made this setting change to Google Chrome when the desktop computer was new, and two years passes when the user gets a new desktop computer, it is highly unlikely the user will remember how to configure Google Chrome to automatically open .pdf files after they are downloaded. In any modern device, there are dozens or perhaps hundreds of such user settings. By storing these user settings in the user's U-Me account, the user will not have to remember each and every setting the user makes in each and every device. The same is true for configuring a smart phone. Often users have to search online to figure out how to do certain things, such as setting different ringtones for different contacts. In today's world, such settings are lost when a user changes to a different phone, which requires the user repeat the learning process to configure the new phone. With the U-Me system disclosed herein, all of the user's settings are saved to the user's U-Me account, allowing a new device to be easily configured using the stored user settings.

While the previous paragraph discusses an example of a user setting in Google Chrome, similar concepts apply to user data and user licensed content. There is currently no known way to make all of a user's data, licensed content, and settings available in the cloud so this information is available to the user on any device or system the user decides to use. The Universal Me system solves this problem. The system is called Universal Me because it “allows me to be me, anywhere” for each user. Thus, a user on vacation on Italy could find an Internet café, use a computer in the Internet café to access the user's universal interface to the U-Me system, and would then have access to all of the user's data, licensed content, and settings. Similarly, the user could borrow an iPad from a friend, and have access to all the user's data, licensed content, and settings. The power and flexibility of the U-Me system leads to its usage in many different scenarios, several of which are described in detail below.

While many different categories of user settings are shown in FIG. 8, these are shown by way of example. A benefit of the U-Me system is that a user only has to configure a device once, and the configuration for that device is stored in the user's U-Me account. Replacing a device that is lost, stolen, or broken is a simple matter of buying a new similar device, then following the instructions provided by the U-Me system to configure the new device to be identical to the old device. In the most preferred implementation, the U-Me system will back up all user data, licensed content, and settings related to the device to the user's U-Me account, which will allow the U-Me system to configure the new device automatically with minimal input from the user. However, features of the devices themselves may prevent copying all the relevant data, licensed content and settings to the user's U-Me account. When this is the case, the U-Me system will provide instructions to the user regarding what steps the user needs to take before the U-Me system can configure the device with the information stored in the user's U-Me account.

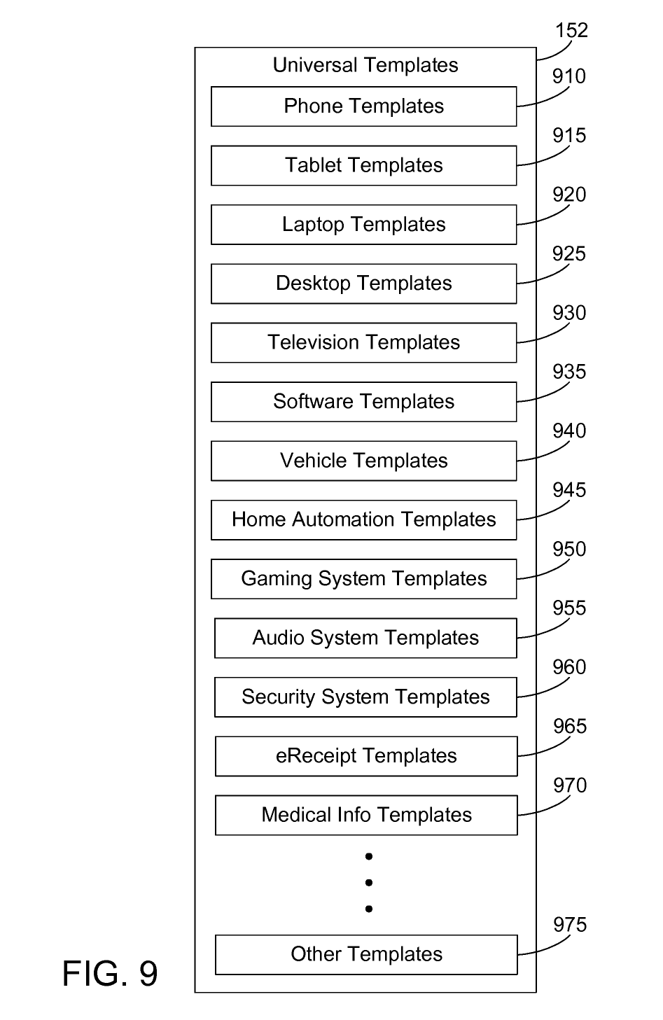

The U-Me system could use various templates that define settings for different physical devices. Referring to FIG. 9, universal templates 152 include phone templates 910, tablet templates 915, laptop templates 920, desktop templates 925, television templates 930, software templates 935, vehicle templates 940, home automation templates 945, gaming system templates 950, audio system templates 955, security system templates 960, eReceipt templates 965, medical information templates 970, and other templates 975. The universal templates shown in FIG. 9 are examples shown for the purpose of illustration. The disclosure and claims herein extend to any suitable universal templates, including universal templates related to devices known today as well as universal templates related to devices developed in the future.

The various universal templates in FIG. 9 include categories of devices that may include user settings. One of the benefits of the U-Me system is the ability for a user to store settings for any device or type of device that requires configuration by the user. This allows a user to spend time once to configure a device or type of device, and the stored settings in the user's U-Me account will allow automatically configuring identical or similar devices. The U-Me system expressly extends to storing any suitable user data and/or user licensed content and/or user settings for any suitable device in a user's U-Me account.

The universal templates 152 provide a platform-independent way of defining settings for a particular type of device. Thus, a universal phone template may be defined by a user using the U-Me system without regard to which particular phone the user currently has or plans to acquire. Because the universal templates are platform-independent, they may include settings that do not directly map to a specific physical device. Note, however, the universal templates may include information uploaded from one or more physical devices. The universal template can thus become a superset of user data, user licensed content, and user settings for multiple devices. The universal templates can also include settings that do not correspond to a particular setting on a particular physical device.

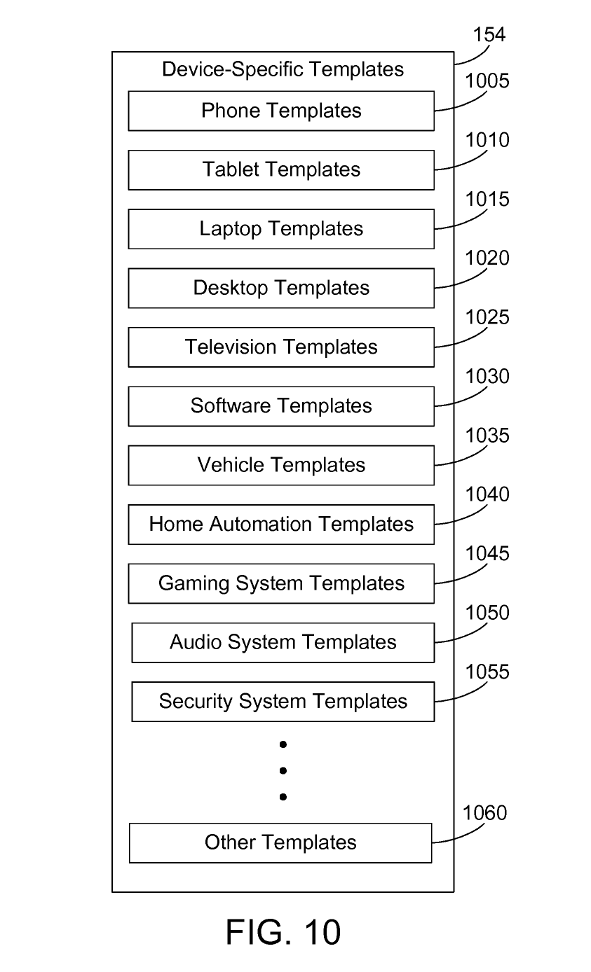

Referring to FIG. 10, device-specific templates 154 include phone templates 1005, tablet templates 1010, laptop templates 1015, desktop templates 1020, television templates 1025, software templates 1030, vehicle templates 1035, home automation templates 1040, gaming system templates 1045, audio system templates 1050, security system templates 1055, and other templates 1060. The device-specific templates shown in FIG. 10 are examples shown for the purpose of illustration. The disclosure and claims herein extend to any suitable device-specific templates, including device-specific templates for devices known today as well as device-specific templates for devices developed in the future.

The device-specific templates 154 provide platform-dependent templates. Thus, the user data, user licensed content, and user settings represented in a device-specific template includes specific items on a specific device or device type. The device-specific templates 154 may also include mapping information to map settings in a physical device to settings in a universal template.

The device-specific templates could be provided by any suitable entity. For example, the U-Me system may provide some of the device-specific templates. However, some device-specific templates will preferably be provided by manufacturers of devices. As discussed below, the U-Me system includes the capability of device manufacturers to become “U-Me Certified”, which means their devices have been designed and certified to appropriately interact with the U-Me system. Part of the U-Me certification process for a device manufacturer could be for the manufacturer to provide a universal template for each category of devices the manufacturer produces, a device-specific template for each category of devices the manufacturer produces, as well as a device-specific template for each specific device the manufacturer produces.

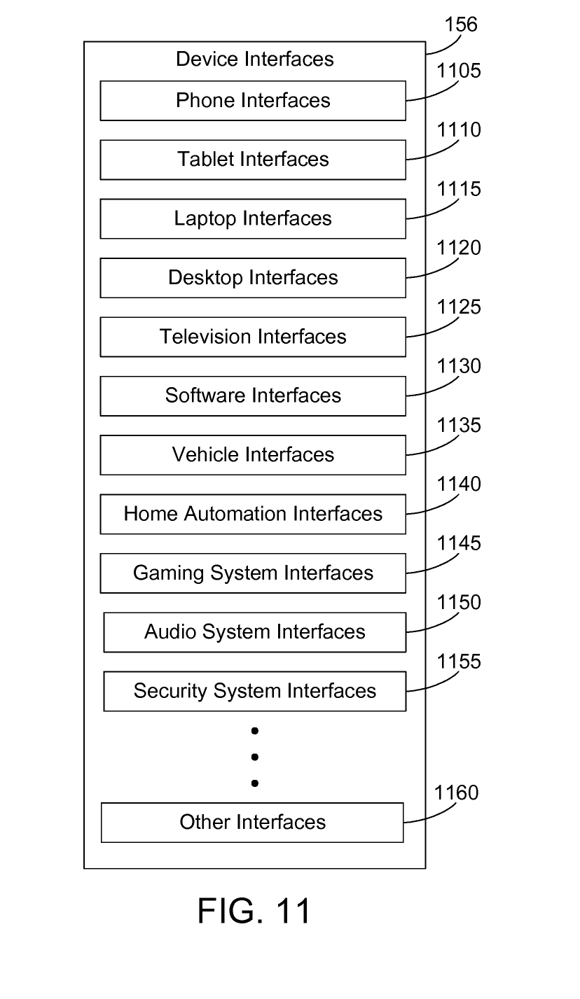

Referring to FIG. 11, device interfaces 156 preferably include phone interfaces 1105, tablet interfaces 1110, laptop interfaces 1115, desktop interfaces 1120, television interfaces 1125, software interfaces 1130, vehicle interfaces 1135, home automation interfaces 1140, gaming system interfaces 1145, audio system interfaces 1150, security system interfaces 1155, and other interfaces 1160. The device interfaces shown in FIG. 11 are examples shown for the purpose of illustration. The disclosure and claims herein extend to any suitable device interfaces, including device interfaces for devices known today as well as device interfaces for devices developed in the future.

Each device interface provides the logic and intelligence to interact with a specific type of device or with a specific device. Thus, phone interfaces 1105 could include an iPhone interface and an Android interface. In addition, phone interfaces 1105 could include different interfaces for the same type of device. Thus, phone interfaces 1105 could include separate phone interfaces for an iPhone 4 and an iPhone 5. In the alternative, phone interfaces 1105 could be combined into a single phone interface that has the logic and intelligence to communicate with any phone. In the most preferred implementation, a device interface is provided for each specific device that will interact with the U-Me system. This could be a requirement for a device to become U-Me certified, that the manufacturer of the device provide the device interface that meets U-Me specifications.

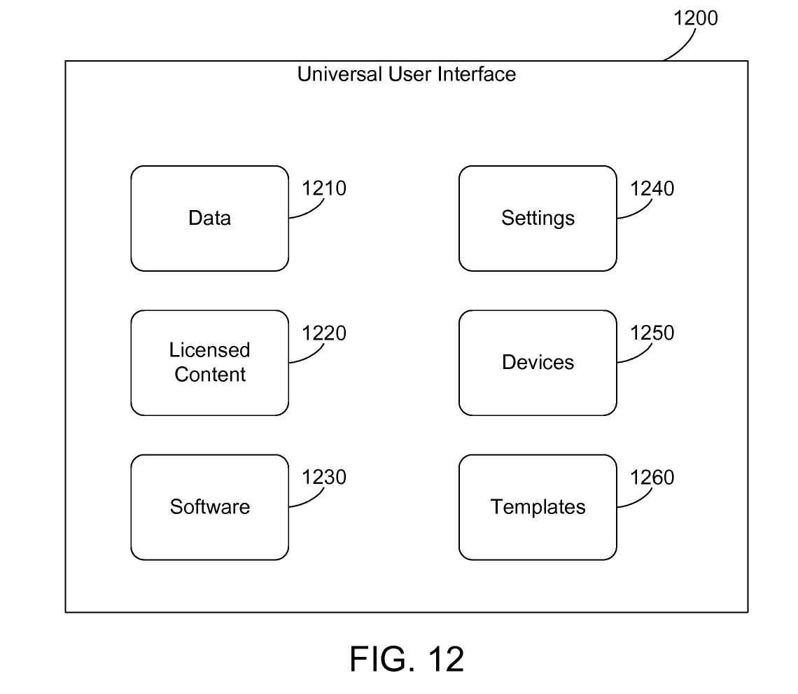

The U-Me system preferably includes a universal user interface 142 shown in FIG. 5. The universal user interface 1200 shown in FIG. 12 is one suitable example of a specific implementation for the universal user interface 142 shown in FIG. 5. The universal user interface 1200 in FIG. 12 includes several icons the user may select to access various features in the U-Me system. The icons shown in FIG. 12 include a data icon 1210, a licensed content icon 1220, a software icon 1230, a settings icon 1240, a devices icon 1250, and a templates icon 1260. Selecting the data icon 1210 gives the user access to the user data 120 stored in the user's U-Me account, including the types of data shown in FIG. 6. One way for the user to access the user data 120 is via a data search engine, discussed in more detail below. Selecting the licensed content icon 1220 gives the user access to any and all of the user's licensed content 130, including the categories of licensed content shown in FIG. 7. Selecting the software icon 1230 gives the user access to software available in the user's U-Me account. While software is technically a category of licensed content (see 735 in FIG. 7), a separate icon 1230 could be provided in the universal user interface 1200 in FIG. 12 because most users would not mentally know to select the licensed content icon 1220 to run software. Selecting the software icon 1230 results in a display of the various software applications available in the user's U-Me account. The user may then select one of the software applications to run. The display of software icons after selecting the software icon 1230 could be considered a “virtual desktop” that is available anywhere via a browser or other suitable interface.

Selecting the settings icon 1240 gives the user access to any and all of the user settings 140, including the categories of settings shown in FIG. 8. Selecting the devices icon 1250 gives the user access to virtual devices, which are discussed in more detail below, where the virtual devices correspond to a physical device used by the user. The user will also have access to the device interfaces 156, including the device interfaces shown in FIG. 11. Accessing devices via the device interfaces allows the user to have remote control via the universal user interface over different physical devices. Selecting the templates icon 1260 gives the user access to the templates in the user's U-Me account, including: universal templates, including the universal templates shown in FIG. 9; and device-specific templates, including those shown in FIG. 10. The devices icon 1250 and the templates icon 1260 provide access to information in the user's U-Me account pertaining to devices and templates, which can be part of the settings in the user's U-Me account. While the Devices icon 1250 and Templates icon 1260 could be displayed as a result of a user selecting the Setting icon 1240, these icons 1250 and 1260 that are separate from the settings icon 1240 could be provided as shown in FIG. 23 to make using the universal user interface 1200 more intuitive for the user.

The universal user interface gives the user great flexibility in accessing a user's U-Me account. In the most preferred implementation, the universal user interface is browser-based, which means it can be accessed on any device that has a web browser. Of course, other configurations for the universal user interface are also possible, and are within the scope of the disclosure and claims herein. For example, a user on vacation in a foreign country can go into an Internet café, invoke the login page for the U-Me system, log in, and select an icon that causes the universal user interface (e.g., 1200 in FIG. 12) to be displayed. The user then has access to any and all information stored in the user's U-Me account.

Because the universal user interface allows a user to access the user's U-Me account on any device, the universal user interface also provides a way for a user to change settings on the user's devices. Because the user's U-Me account includes virtual devices that mirror the configuration of their physical device counterparts, the user could use a laptop or desktop computer to define the settings for the user's phone. This can be a significant advantage, particularly for those who don't see well or who are not dexterous enough to use the tiny keypads on a phone. A simple example will illustrate. Let's assume a U-Me user wants to assign a specific ringtone to her husband's contact info in her phone. The user could sit down at a desktop computer, access the universal user interface 1200, select the Devices icon 1250, select a Phone icon, which then gives the user access to all of the settings in the phone. The user can then navigate a menu displayed on a desktop computer system using a mouse and full-sized keyboard to change settings on the phone instead of touching tiny links and typing on a tiny keyboard provided by the phone. The user could assign the ringtone to her husband's contact info in the settings in the virtual device in the U-Me account that corresponds to her phone. Once she makes the change in the virtual phone settings in the U-Me account, this change will be automatically propagated to her phone. The universal user interface may thus provide access to the user to set or change the settings for all of the user's physical devices.

The universal user interface 142 can include any suitable interface type. In fact, the universal user interface 142 can provide different levels of interfaces depending on preferences set by the user. Thus, the universal user interface may provide simple, intermediate, and power interfaces that vary in how the information is presented to the user depending on the user's preferences, which could reflect the technical prowess and capability of the user. Those who are the least comfortable with technology could select a simple interface, which could provide wizards and lots of help context to help a user accomplish a desired task. Those more comfortable with technology could select the intermediate interface, which provides fewer wizards and less help, but allows a user to more directly interact with and control the U-Me system. And those who are very technically-oriented can select the power interface, which provides few wizards or help, but allows the user to directly interact with and control many aspects of the U-Me system in a powerful way.

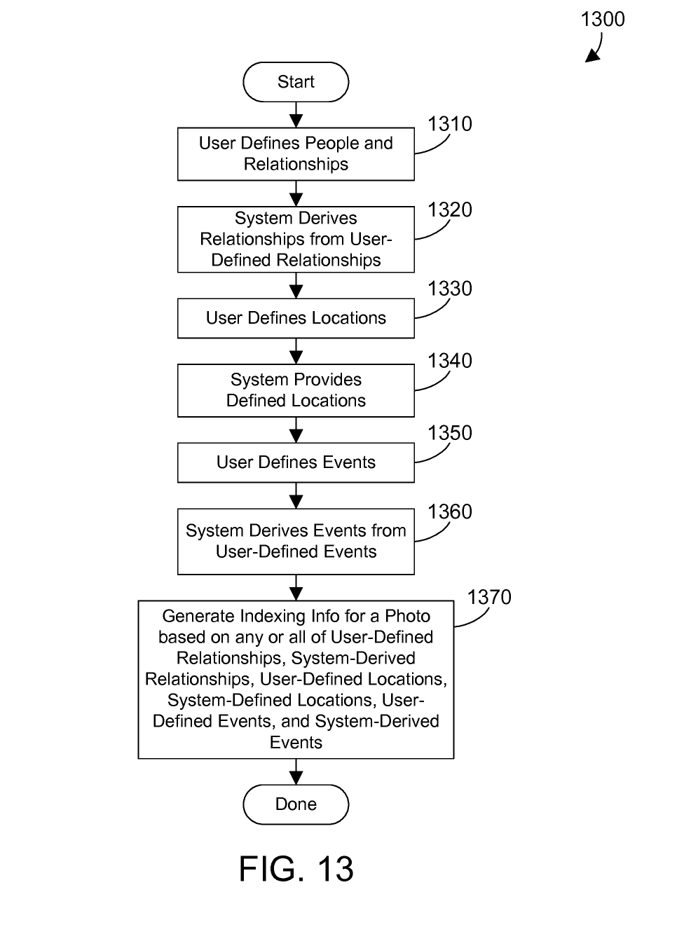

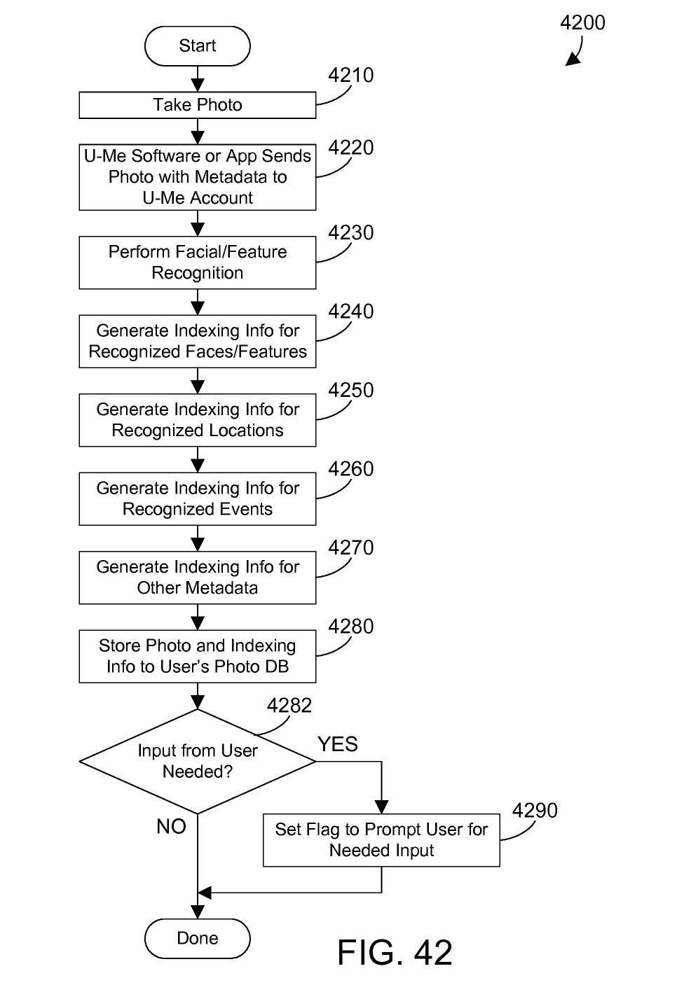

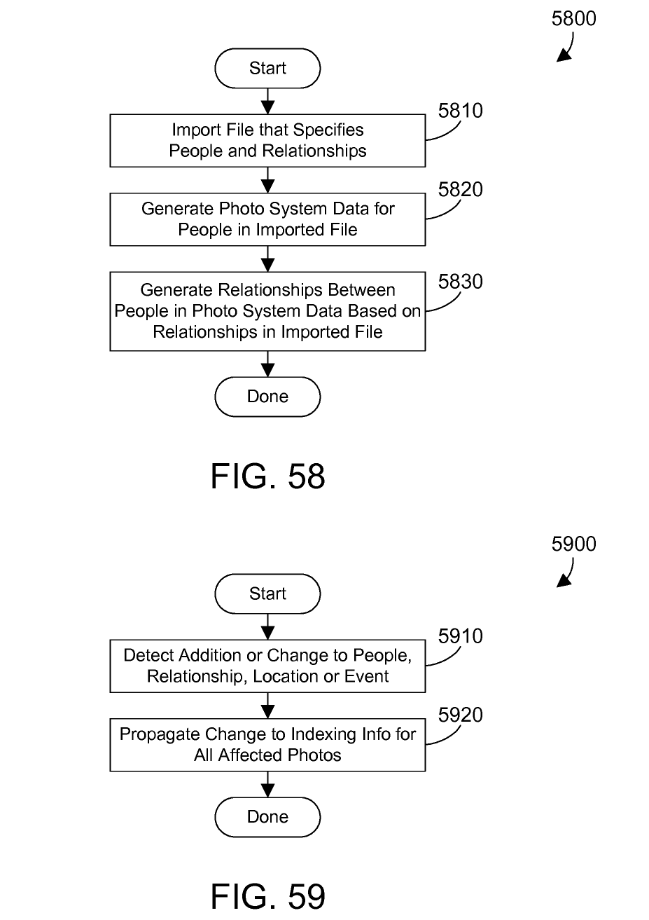

As discussed above, the widespread acceptance of digital photography has been accompanied by a corresponding widespread problem of most users having thousands of digital photos that are stored using cryptic names in many different directories or folders on their computer systems, making retrieval of photographs difficult. The U-Me system provides an improved way to manage photos, including photos that originated from a digital camera or other digital device, along with hard copy photos that have been digitized for electronic storage. The U-Me system improves over the known art of software that adds metadata to photos by providing a people-centric approach to managing photos, as described in detail below. The methods discussed with respect to FIGS. 13-59 are preferably performed by the photo mechanism 182 shown in FIG. 5.

Referring to FIG. 13, a method 1300 generates and stores indexing information for a photo. A user defines people and relationships in the U-Me system (step 1310). The U-Me system derives relationships from the user-defined relationships (step 1320). The user may also define one or more locations (step 1330). The U-Me system may also provide defined locations (step 1340). The user may also define one or more events (step 1350). The U-Me system derives events from the user-defined events (step 1360). The U-Me system then generates indexing info for a photo based on any or all of the user-defined relationships, system-derived relationships, user-defined locations, system-defined locations, user-defined events, and system-derived events (step 1370).

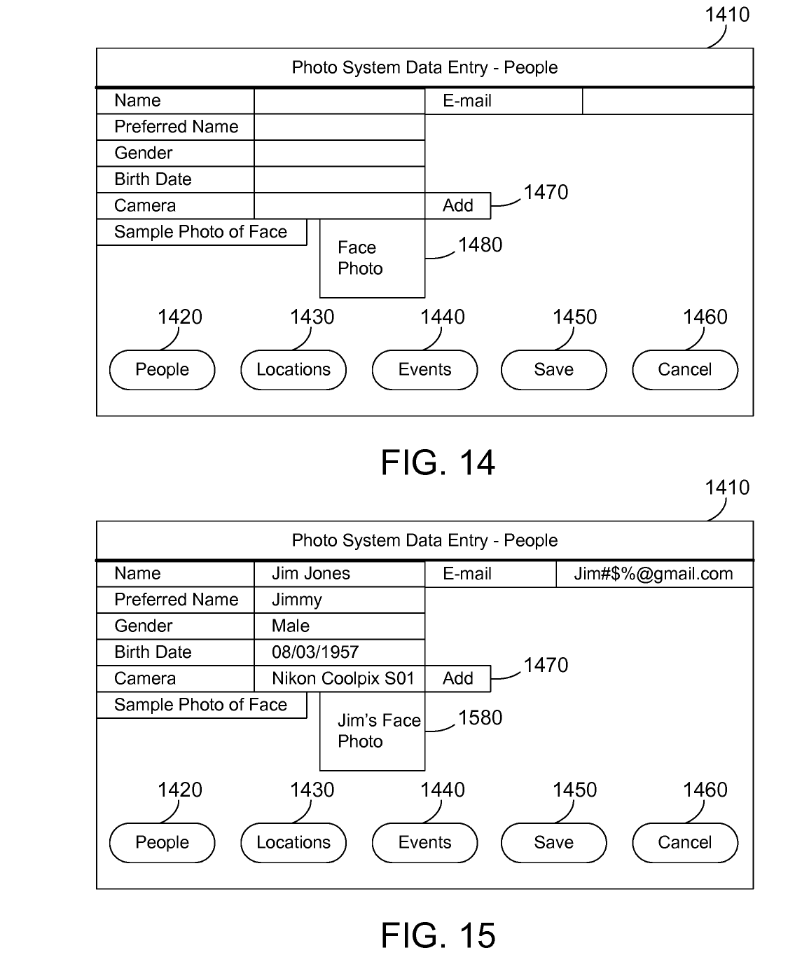

The U-Me system includes a photo system data entry screen for people, such as screen 1410 shown in FIG. 14 by way of example. The photo system data entry screen 1410, like all of the U-Me system, is person-centric. Thus, when a user decides to have the U-Me system manager the user's photos, the user starts by entering data for a particular person in the photo system data entry screen 1410. Fields in the photo system data entry screen 1410 include Name, Preferred Name, Birth Date and Camera. The user can provide a sample photo of the person's face at 1480 to help train the facial recognition engine in the U-Me photo system. Note the Camera field includes an Add button 1470 that allows the user to enter all cameras the user uses to take digital photos. The data entry screen for people 1410 shown in FIG. 14 includes a People button 1420, a Locations button 1430, an Events button 1440, a Save button 1450, and a Cancel button 1460.

FIG. 15 shows the data entry screen for people 1410 after a user has entered information into the data entry screen. We assume the user is Jim Jones, and screen 1410 in FIG. 15 shows the pertinent information relating to Jim Jones, including a Preferred Name of Jimmy, a Gender of Male, a Birth Date of 08/03/1957, a Nikon Coolpix S01 Camera, and a photo 1580 showing Jim's face. Once the Save button 1450 is selected, an entry into the user's people database will be created for Jim Jones with the info shown in FIG. 15.

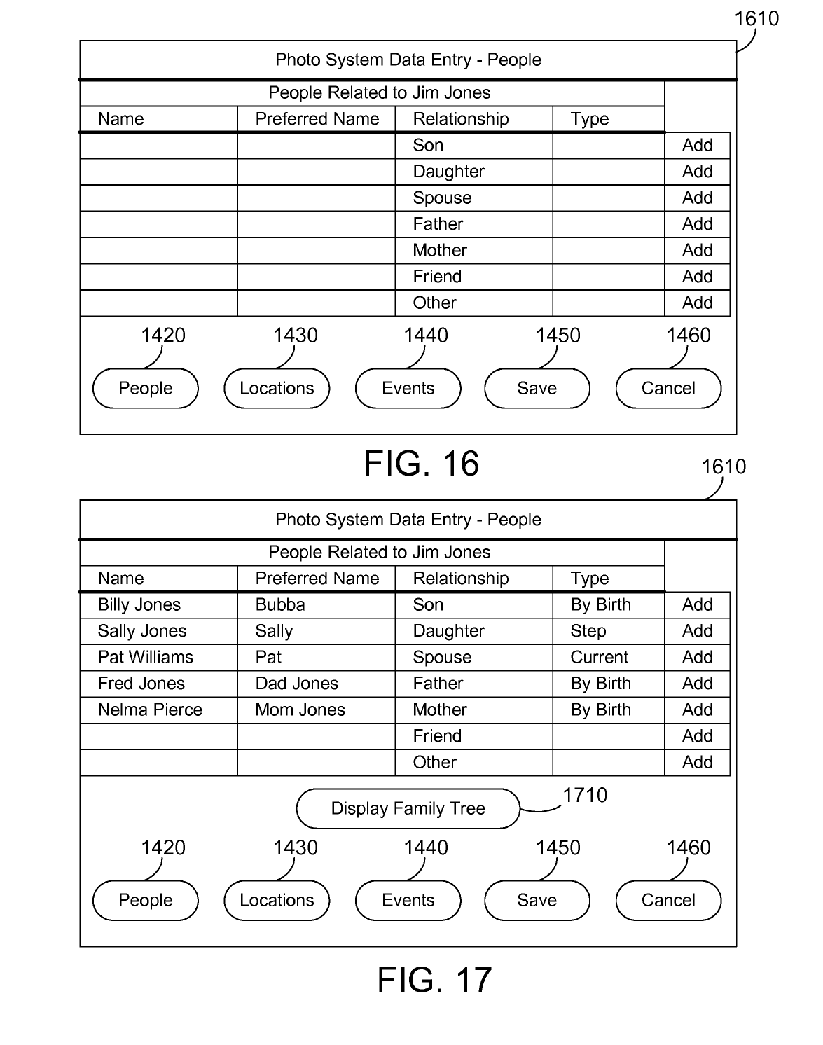

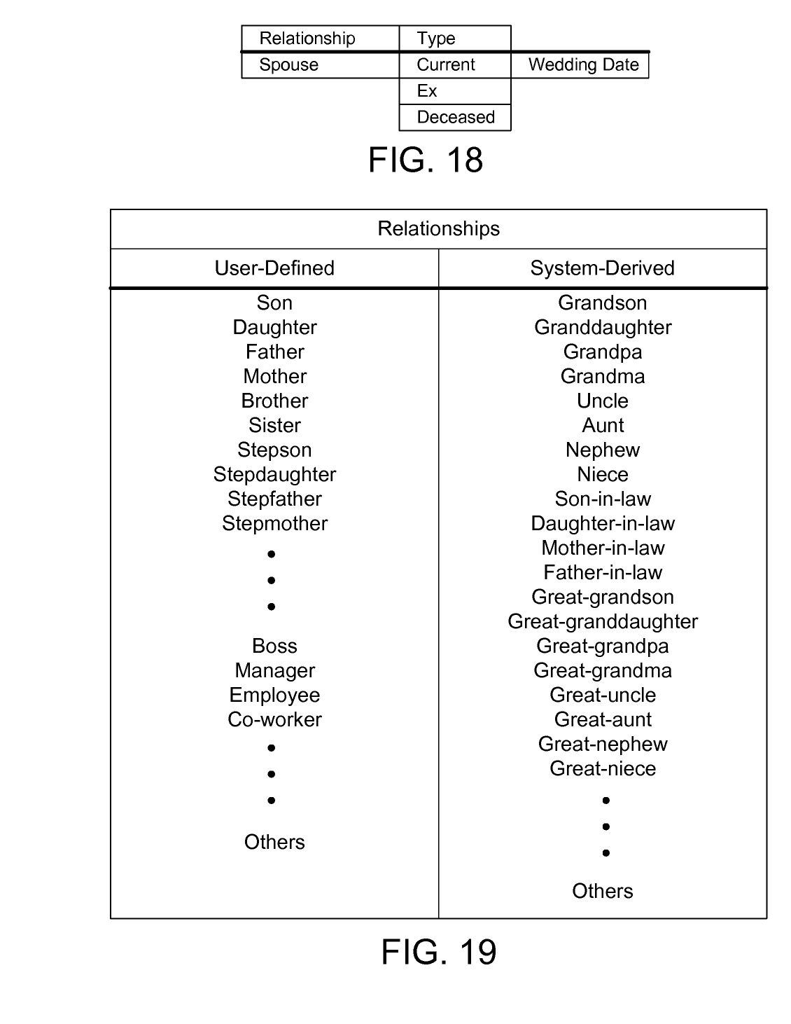

After selecting the Save button 1450 in FIG. 15, we assume the user selects the People button 1420, which results in a different photo entry screen 1610 in FIG. 16 being displayed to the user. Data entry screen 1610 allows entering relationships for Jim Jones. In the specific example shown in FIG. 16, the user can enter family relationships. Thus, Jim Jones adds all the information relating to members of his family, as shown in screen 1610 in FIG. 17. We assume for this example Jim Jones has a son named Billy Jones with a preferred name of Bubba who is Jim's son by birth, a daughter names Sally Jones with a preferred name of Sally who is Jim's stepdaughter, a wife named Pat who is Jim's current wife, a father named Fred Jones with a preferred name of Dad Jones who is Jim's birth father, and a mother named Nelma Pierce with a preferred name of Mom Jones who is Jim's birth mother. After entering the information shown in screen 1610 in FIG. 17, the user can select the Save button 1450, which results in saving all of the people as people in the user's U-Me database, and which results in saving all the relationships relating to these people. Note that entering information about a spouse can include a type of spouse, such as Current, Ex and Deceased, as shown in FIG. 18, along with a wedding date. Once a user enters any family members into the data entry screen 1610 shown in FIG. 17, a Display Family Tree button 1710 is displayed that, when selected, will display a family tree of all the relationships for the user. Note that once a person is entered into the user's People database, the user can enter more information for that person by invoking the data entry screens 1410 and 1610.

The initial entry of photo system data for all the people in a user's immediate and extended family may take some time, but once this work is done the U-Me system can use this data in many ways that allow easily storing photos to and easily retrieving photos from the user's U-Me account. In addition, this data relating to people can be shared with others, thus allowing a first user to provide a significant shortcut to a second user who is invited to share the first user's photos as well as people, locations, events, etc.

The U-Me system is intelligent enough to derive many relationships that are not explicitly specified by a user. For example, FIG. 19 shows user-defined relationships can include son, daughter, father, mother, brother, sister, stepson, stepdaughter, stepfather, stepmother, boss, manager, employee, co-worker, and others. Examples of system-derived relationships in FIG. 19 include grandson, granddaughter, grandpa, grandma, uncle, aunt, nephew, niece, son-in-law, daughter-in-law, mother-in-law, father-in-law, great-grandson, great-granddaughter, great-grandpa, great-grandma, great-uncle, great-aunt, great-nephew, great-niece and others. Note that all of the relationships shown in FIG. 19 are for illustration only, and are not limiting. Other user-defined relationships and system-derived relationships not shown in FIG. 19 are within the scope of the disclosure and claims herein. For example, the system could derive any suitable relationship, such as second cousin twice removed, third-level employee, etc.

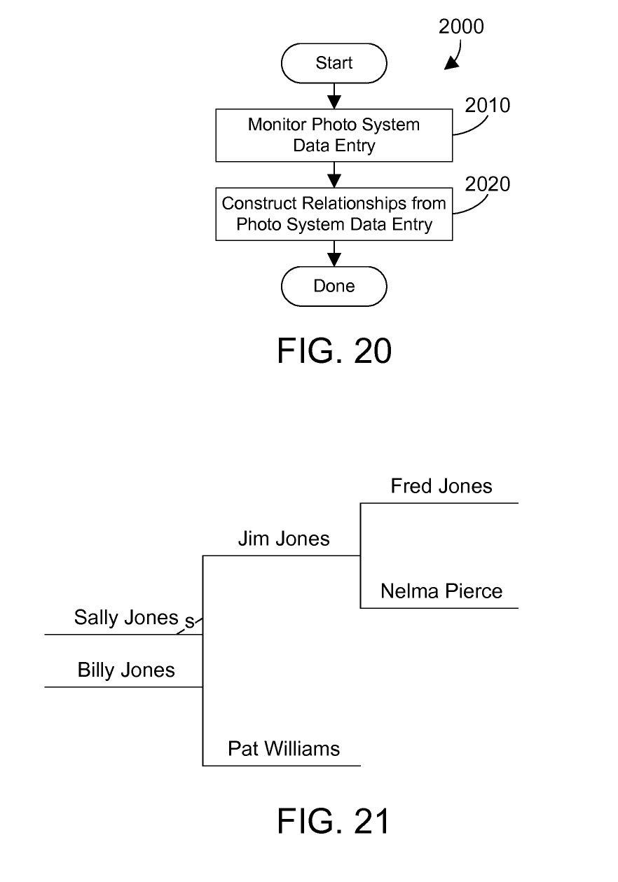

Referring to FIG. 20, as entries are made into the photo system (e.g., as shown in FIGS. 15 and 17), method 2000 monitors the photo system data entry (step 2010) and constructs relationships from the photo system data entry (step 2020). People naturally think along the lines of family relationships and other relationships between people. While known software for adding metadata to a photo allows adding name labels such as “Katie” and performing facial recognition, these labels have no meaning within the context of other people in the photos. The U-Me system, in contrast, constructs relationships between people, such as family relationships, that allow storing and retrieving photos much more effectively than in the prior art.

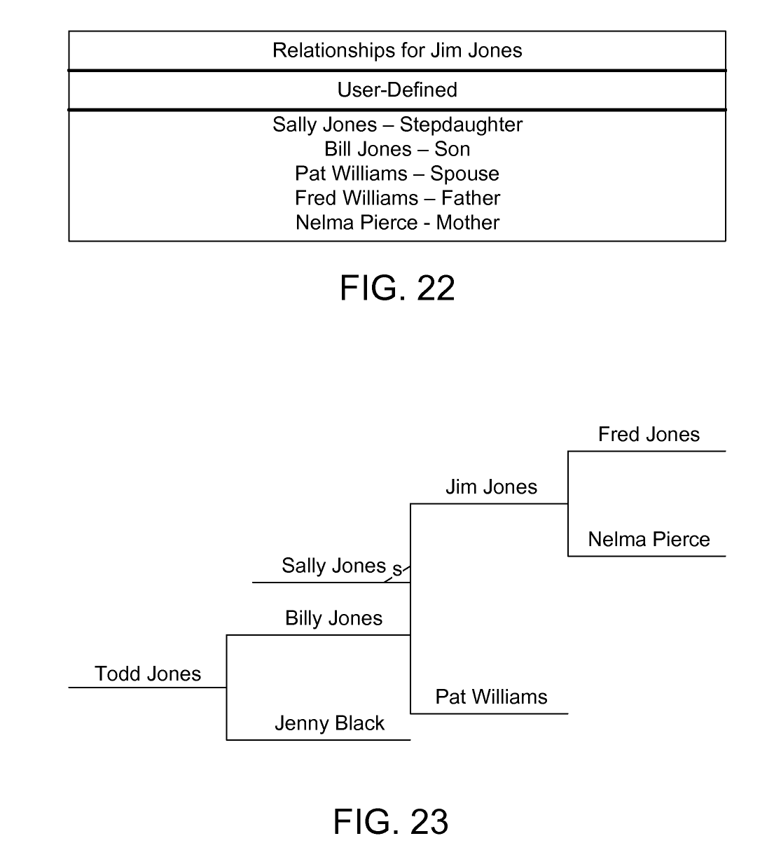

FIG. 21 shows a display of a family tree that could be displayed when the user clicks on the Display Family Tree button 1710 after saving the information in the data entry screen 1610 as shown in FIG. 17. Note there is a small “s” next so Sally Jones' name to indicate she is a step-daughter of Jim, not a daughter by birth. The user-defined relationships for Jim Jones specified in FIG. 17 are shown in FIG. 22. Now we assume the user selects Billy Jones in the user's People database, and enters information in the data entry screen 1610 shown in FIG. 16 that indicates Billy married Jenny Black and has a son by birth named Todd Jones. This additional information is dynamically added to the family tree as it is entered. The resulting family tree is shown in FIG. 23.

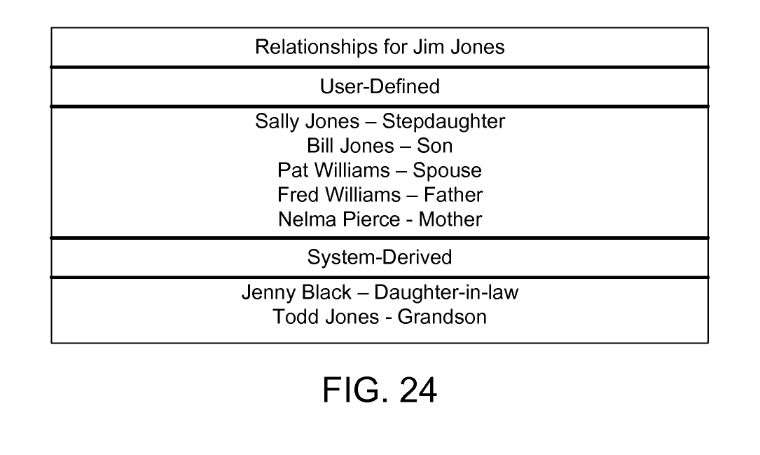

FIG. 24 shows the addition of Jenny Black and Todd Jones results in the creation of some system-derived relationships. The U-Me system recognizes the wife of a son is a daughter-in-law, and thus derives from the fact that Jenny Black is listed as Billy Jones' wife that Jenny Black is the daughter-in-law of Jim Jones. In similar fashion, the U-Me system recognizes the son of a son is a grandson, and thus derives from the fact that Todd Jones is listed as Billy Jones' son that Todd Jones is the grandson of Jim Jones. As the family tree is expanded by adding more user-defined relationships, the U-Me system will monitor the additions and dynamically create more system-derived relationships that are derived from the user-defined relationships.

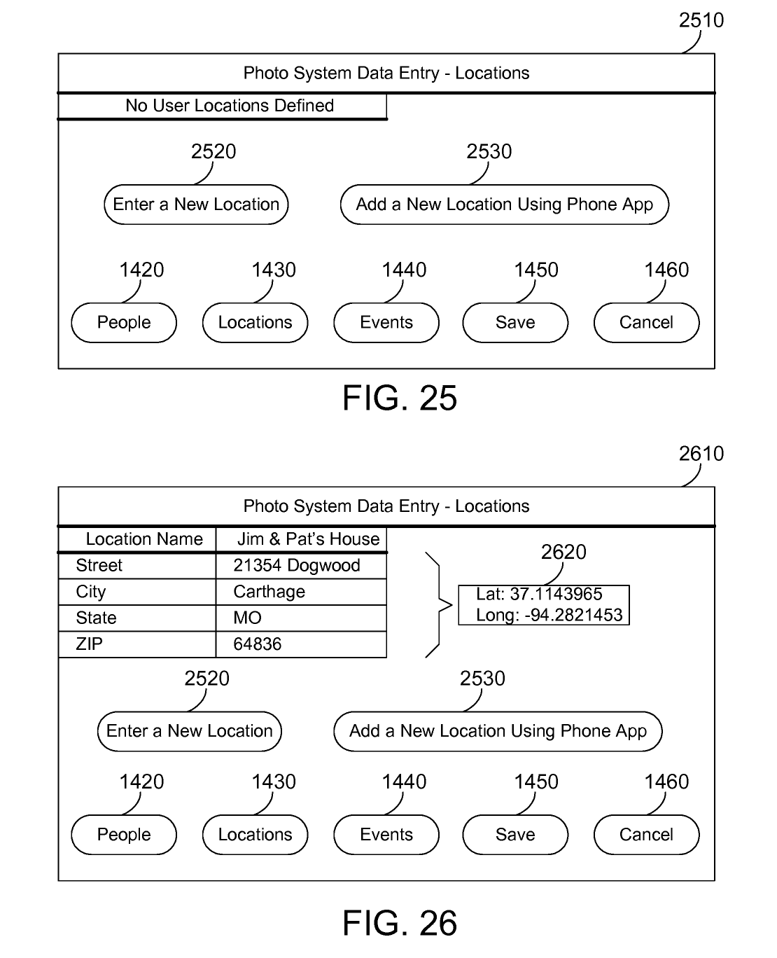

In addition to defining people and relationships, a user can also define locations. For example, we assume selecting the Locations button 1430 in FIGS. 14-17 results in the display of a locations data entry page, of which an example 2510 is shown in FIG. 25. The data entry screen for locations 2510 may include a button 2520 to enter a new location or a button 2530 to add a new location using a phone app. We assume the user selects the Enter a New Location button 2520, which could result, for example, in the display of the data entry screen 2610 shown in FIG. 26. In FIG. 26, the location is named Jim & Pat's House, the street address is 21354 Dogwood, the city is Carthage, the state is Missouri (postal abbreviation of MO), and the ZIP code is 64836. When the user enters the location information in the Street, City, State, and ZIP fields, the U-Me system computes GPS coordinates for that location, and stores those GPS coordinates at 2620 relating to the address of the person whose information appears on the screen 2610.

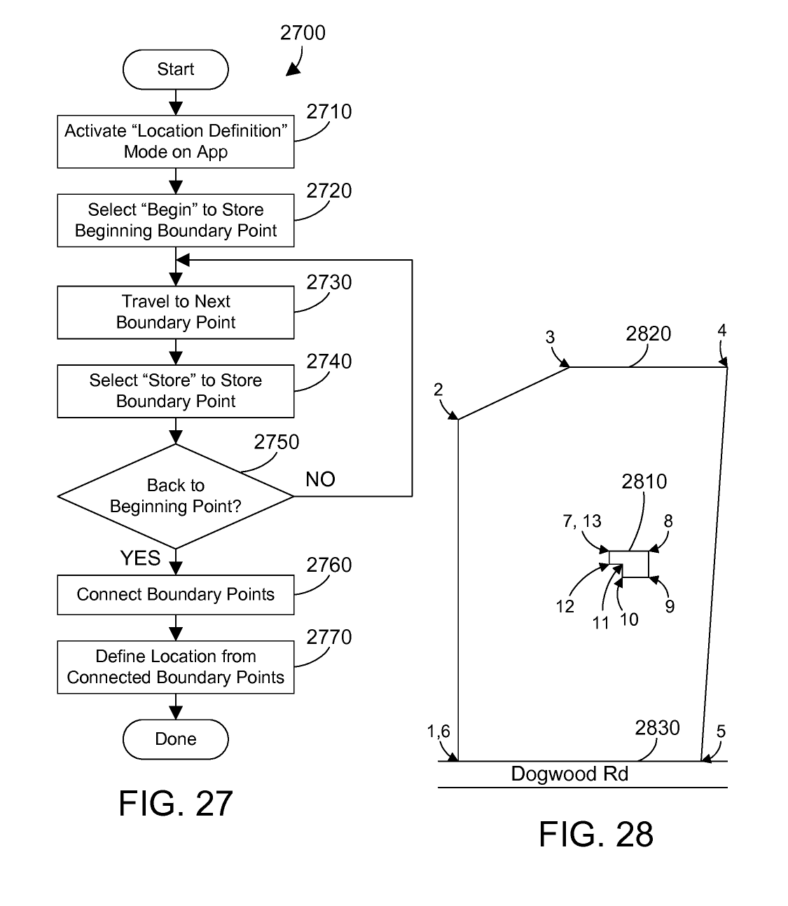

The U-Me system includes the capability of allowing a user to define any suitable location using the U-Me app on the user's smart phone or other mobile device, such as when the user selects button 2530 in FIG. 25 or 26. Method 2700 in FIG. 27 shows an example of a method for a user to define a location using the user's smart phone. The user invokes the U-Me app on the user's smart phone, then activates a “location definition” mode on the U-Me app (step 2710). The user then selects the “Begin” button, which causes the current location of the smart phone to be stored as the beginning boundary point (step 2720). The user then travels to the next boundary point (step 2730), and selects “store” on the U-Me app (step 2740) to store the current location of the smart phone as the next boundary point. When the current boundary point is not the beginning point (step 2750=NO), method 2700 loops back to step 2730, and the user continues to enter boundary points until the user is back to the beginning (step 2750=YES). The boundary points are then connected (step 2760), preferably using straight lines in connect-the-dot fashion. A location is then defined from the region enclosed by the boundary points (step 2770). The coordinates for the region are then sent from the U-Me app to the U-Me system, thereby defining a location for the user in the user's U-Me account. In one particular implementation, the coordinates are GPS coordinates, but any suitable location coordinates could be used.

FIG. 28 illustrates examples of how method 2700 could be used by a user to define locations in the user's U-Me system. We assume for this example that Jim & Pat's house is in a rural area on 40 acres of land that has an irregular shape. We assume Jim uses the U-Me app on his smart phone, walks to a corner of his property shown at points 1,6 in FIG. 28, activates the “location definition” mode on the U-Me app (step 2710), and selects Begin on the U-Me app (step 2720), which stores point 1 as the Begin point. Jim then walks to point 2 (step 2730), the next corner of his property, and selects Store on the U-Me app to store point 2 as the next boundary point (step 2740). Point 2 is not back to the beginning point (step 2750=NO), so Jim walks to point 3 in FIG. 28 (step 2730) and selects Store on the U-Me app to store point 3 as the next boundary point (step 2740). Point 3 is not back to the beginning point (step 2750=NO), so Jim walks to point 4 in FIG. 28 (step 2730) and selects Store on the U-Me app to store point 4 as the next boundary point (step 2740). Point 4 is not back to the beginning point (step 2750=NO), so Jim walks to point 5 in FIG. 28 (step 2730) and selects Store on the U-Me app to store point 5 as the next boundary point (step 2740). Point 5 is not back to the beginning point (step 2750=NO), so Jim walks to point 6 in FIG. 28 (step 2730) and selects Store on the U-Me app to store point 6 as the next boundary point (step 2740). Because point 6 is the same point as point 1, which was the beginning, the U-Me app recognizes the user is back to the beginning point (step 2750=YES). The U-Me app connects the boundary points (step 2760), and defines a location from the connected boundary point (step 2770). The geographical coordinates for this location can then be sent to the user's U-Me account, and the user can then name the location. We assume for this example the location 2820 shown in FIG. 28 that was defined by the user is named “Jim & Pat's Property.”

In FIG. 26, when the address was entered for Jim & Pat's House, the U-Me system computed latitude and longitude coordinates for that location based on a database of addresses with corresponding location coordinates. However, in a rural area, the location coordinates for an address may not correspond very closely to the location of the house. For example, the location coordinates shown in FIG. 26 might correspond to the driveway entrance to Dogwood Road shown at 2830 in FIG. 28. If the house sits back from the road a substantial distance, the location coordinates of the address may not be accurate for the location of the house. Thus, Jim could use the U-Me app to walk the boundary points of his house, shown at points 7, 8, 9, 10, 11, 12 and 13 in FIG. 28. The U-Me app could then connect the boundary points and define a location 2810. This user-defined location 2810 could be substituted for the system-derived location 2620 shown in FIG. 26 to provide a more accurate location of Jim & Pat's house. Note that a photo taken inside of Jim & Pat's house could include indexing information that includes both Jim & Pat's House and Jim & Pat's Property. In the alternative, however, Jim & Pat's Property may be defined specifically to exclude Jim & Pat's house, so a photo taken in Jim & Pat's house will have indexing information generated that indicates the location as Jim & Pat's House, while a photo taken outside the house on the property (for example, of a grandson fishing in a pond) will have indexing information generated that indicates the location as Jim & Pat's Property.

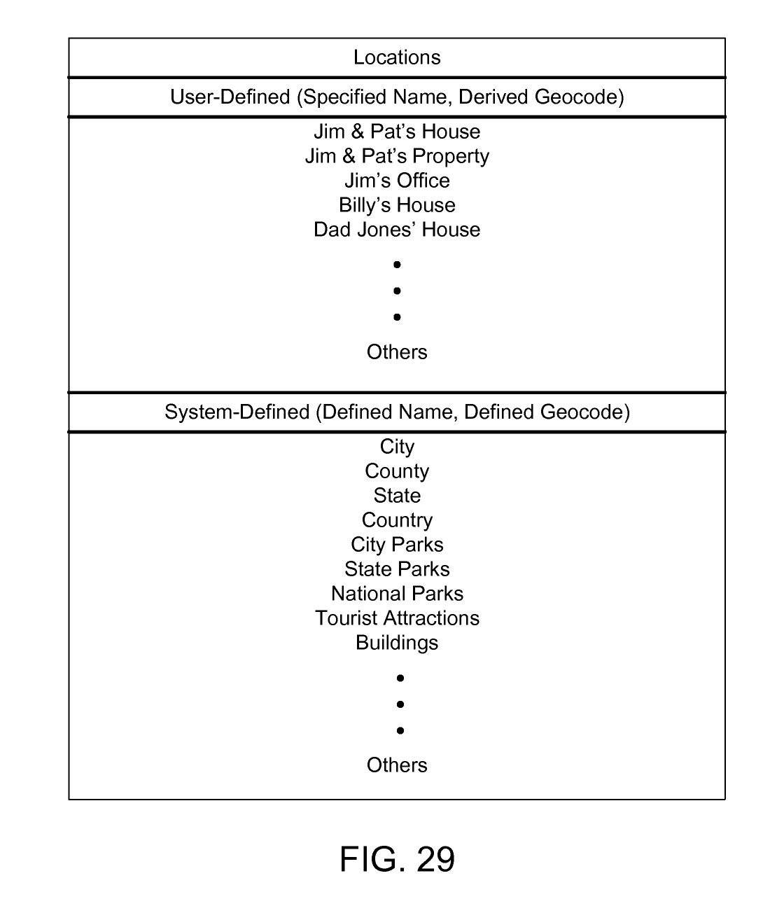

Many modern cameras and almost all smart phones include location information in the metadata of a digital photo file that specifies the location of where the photo was taken. FIG. 29 shows examples of user-defined locations and system-defined locations. User-defined locations have a specified name and derived geocode information that defines the location. For example, the derived geocode information for Jim & Pat's Property defined by the user at 2820 in FIG. 28 is all geographical coordinates that fall within the defined location 2820. The user-defined locations include Jim & Pat's House, Jim & Pat's Property, Jim's Office, Billy's House, Dad Jones' House, etc. The system-defined locations can include any location information available from any suitable source, such as online databases or websites, etc. System-defined locations may include, for example, city, county, state, country, city parks, state parks, national parks, tourist attractions, buildings, etc. Thus, when a photo is taken at the Grand Canyon, the U-Me system can detect the location coordinates, check available databases of system-defined locations, detect the location corresponds to the Grand Canyon, and add a location “Grand Canyon” to indexing info for the photo. The same could be done for tourist attractions such as Disney World, and for buildings such as the Empire State Building. It will be appreciated that a user could define many user-defined locations and the system could define any type and number of system-defined locations. Note that one location can correspond to both a user-defined location and a system-defined location. Thus, if a user owns a cabin in a state park, the user could define the location of the cabin as “Cabin”, and photos could then include indexing information that specifies both the state park and “Cabin”.

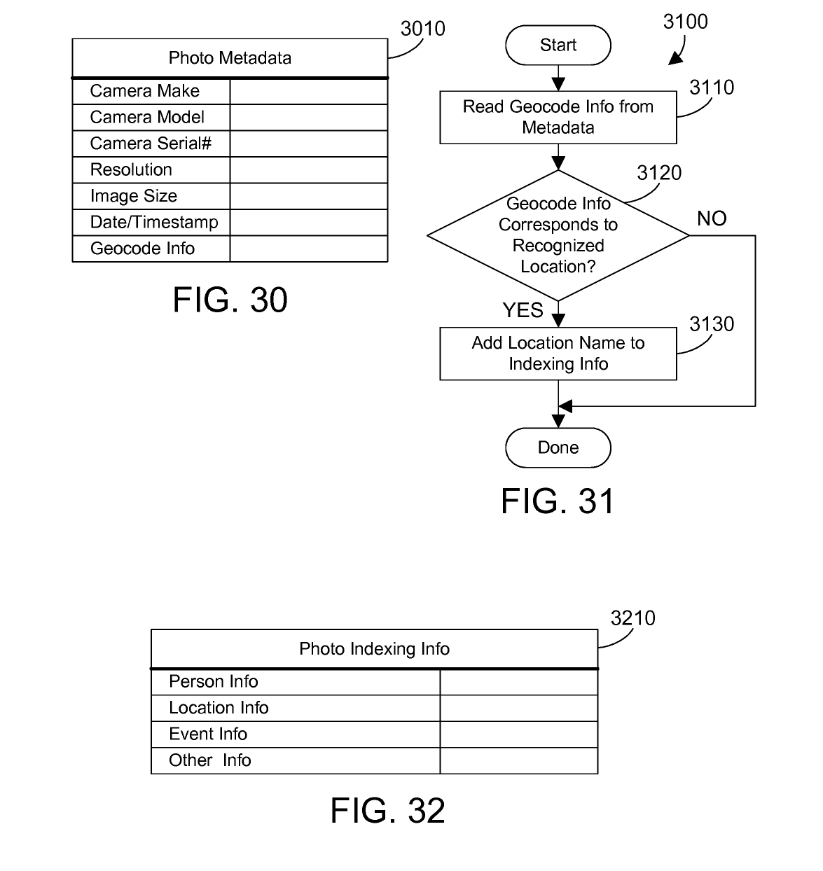

FIG. 30 shows sample metadata 3010 that may exist in known digital photo files. Note the term “metadata” is used herein to mean data that is not part of the visible image in the digital photo that describes some attribute of the photo. The metadata 3010 in FIG. 30 is shown to include fields for Camera Make, Camera Model, Camera Serial Number, Resolution of the photo, Image Size of the photo, Date/Timestamp, and Geocode Info. The metadata shown in FIG. 30 is shown by way of example. Many other fields of metadata are known in the art, such as the metadata fields defined at the website photometadata.org. The photo metadata disclosed herein expressly extends to any suitable data, whether currently known or developed in the future, that is placed in the digital photo file by the device that took the photo to describe some attribute that relates to the photo.

When photo metadata includes geocode info as shown in FIG. 30 that defines the geographical location of where the camera was when the photo was taken (as is common in smart phones), method 3100 in FIG. 31 reads this geocode info from the metadata (step 3110). The geocode info can be in any suitable form such as GPS coordinates or other forms of geographical info that specifies location, whether currently known or developed in the future. The geocode info is processed to determine whether the geocode info corresponds to a recognized location (step 3120). If not (step 3120=NO), method 3100 is done. When the geocode info corresponds to a recognized location (step 3120=YES), the location name is added to the indexing info for the photo (step 3130). For example, let's assume Jim Jones takes a photo with his cell phone of his daughter in his house. The geocode info will reflect that the location corresponds to a stored location, namely, Jim & Pat's House. Jim & Pat's House can then be added to the indexing information, which makes retrieval of photos much easier using a photo search engine.

Referring to FIG. 32, examples of photo indexing info 3210 are shown by way of example to include person info, location info, event info, and other info. Person info can include information relating to a person, including relationship info, both user-defined and system-derived. Location info can include any information relating to a location, including user-defined and system-defined. Event info can include any information relating to a date or date range for the photo, including user-defined events, system-derived events, and system-defined events, as discussed in more detail below.

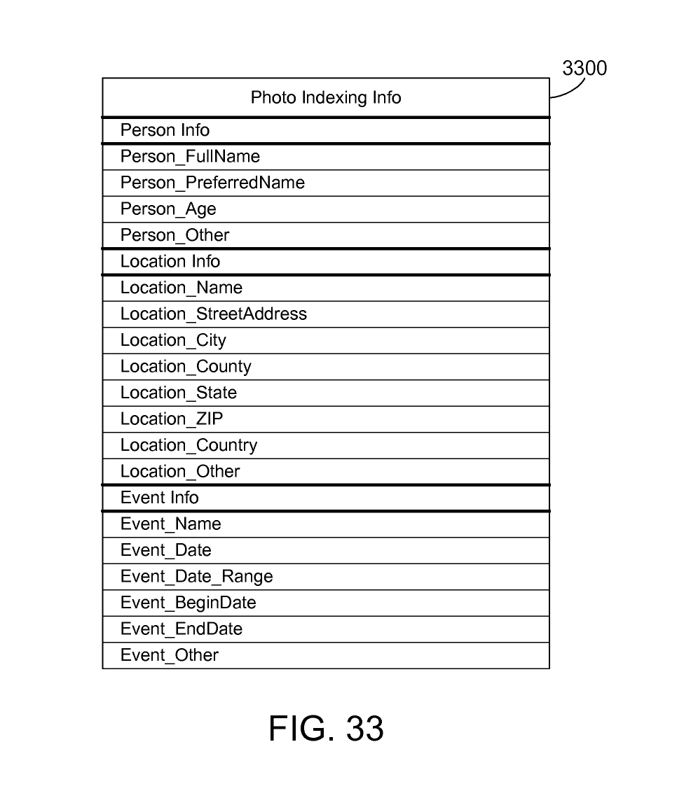

In one suitable implementation, the photo indexing info is generated using tags in a markup language such as eXtensible Markup Language (XML). Sample tags for the photo indexing info 3300 shown in FIG. 33 could include tags in three categories, namely: person info, location info, and event info. The sample tags for Person Info shown in FIG. 33 include Person_FullName, Person_PreferredName, Person_Age and Person_Other. The sample tags for Location Info shown in FIG. 33 include Location_Name, Location_StreetAddress, Location_City, Location_County, Location_State, Location_ZIP, Location_Country, and Location_Other. The sample tags for Event Info shown in FIG. 33 include Event_Name, Event_Date, Event_Date_Range, Event_BeginDate, Event_EndDate, and EventOther. Note the specific tags shown in FIG. 33 are shown by way of example, and are not limiting.

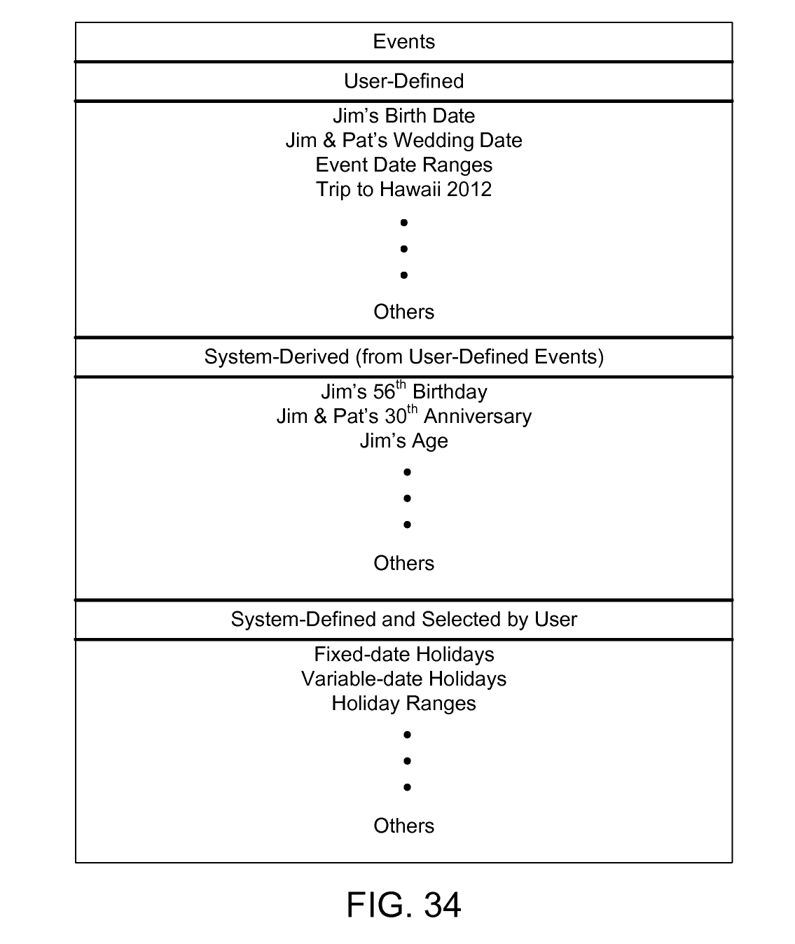

Referring to FIG. 34, events may include user-defined events, system-derived events that are derived from user-defined events, or system-defined events that are selected by the user. Examples of user-defined events include birth dates, wedding dates, events date ranges entered by a user, and labels entered by a user that correspond to a date or date range, and others. Examples of system-derived events include Jim's 56th Birthday, Jim & Pat's 30th Anniversary, Jim's Age, and others. Note that a person's age is not an “event” in a generic sense of the word, but the term “event” as used in the disclosure and claims herein includes anything that can be determined based on a date or date range for a photo, including ages of the people in the photo. Examples of events that are system-defined and selected by a user may include fixed-date holidays, variable-date holidays and holiday ranges. Examples of fixed-date holidays in the United States include New Year's Eve, New Year's Day, Valentine's Day, April Fool's Day, Flag Day, Independence Day, Halloween, Veteran's Day, Christmas Eve, and Christmas Day. Examples of variable-date holidays in the United States include Martin Luther King, Jr. Day, President's Day, Easter, Memorial Day, Labor Day and Thanksgiving. Of course, there are many other fixed-date holidays and variable-date holidays that have not been listed here. Holiday ranges could be defined by the system, and could be selected or modified by the user. For example, an event called “Memorial Day Weekend” could be defined by the system to be the Saturday and Sunday before Memorial Day as well as Memorial Day itself. The user could select this system definition for “Memorial Day Weekend”, or could modify the definition. For example, the user could change the definition of “Memorial Day Weekend” to include the Friday before Memorial Day as well. Similar holiday ranges could be defined for Labor Day Weekend, Thanksgiving Weekend and Christmas Holidays. Again, a user can accept a system-defined holiday range or could modify the system-defined holiday range to the user's liking. Thus, the system could define “Christmas Holidays” to include December 20 to January 1. The user could then modify the system definition of “Christmas Holidays” to include December 15 to January 2. Note the system-defined holidays may include holidays for a number of different countries, nationalities, ethnic groups, etc., which allows a user to select which holidays the user wants to include in indexing information for the user's photos. Thus, a Jewish user could select to include Jewish holidays while excluding Christian holidays.

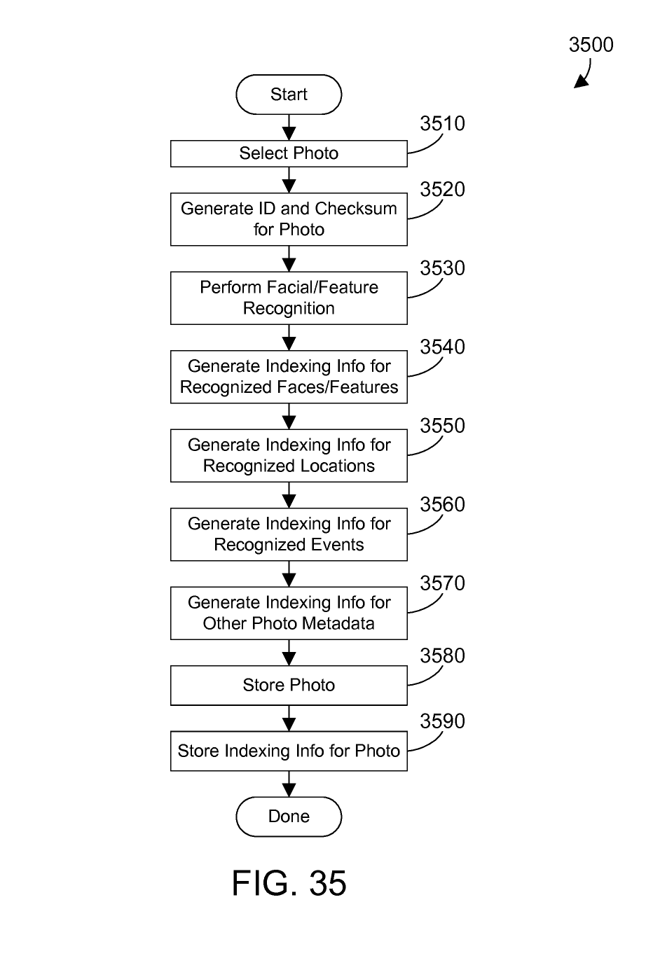

FIG. 35 shows a method 3500 for generating indexing info for a photo. A photo is selected (step 3510). For the purpose of FIG. 35, we assume a photo is a digital photo file. A unique ID and checksum are generated for the photo (step 3520). The unique ID is a simple numerical designator (like a serial number) that uniquely identifies the photo to the U-Me system. The checksum is computed to facilitate detecting duplicate photos, as discussed in more detail below. Facial and feature recognition are performed on the photo (step 3530). Indexing info is generated for recognized faces and features (step 3540). Indexing info is also generated for recognized locations (step 3550) based on the location of the photo. In one specific example, the location may be entered by a user. This could be useful, for example, when a user scans a hard-copy photo to generate a digital photo file that does not include location info. The user could then specify a location, which would be a recognized location for the photo. In another specific example, the location is determined from geocode info embedded in the metadata of the digital photo file. Indexing info is also generated for recognized events (step 3560). Recognized events may include anything relating to a date or date range for the photo, including user-defined events, system-derived events (include ages of people in the photo), and system-defined and user-selected events, as described above with reference to FIG. 34. Indexing info for other photo metadata may also be generated (step 3570). The photo is stored (step 3580), and the indexing info for the photo is also stored (step 3590). In one particular implementation, the indexing info is stored separately from the photo. In an alternative implementation, the indexing info is stored as metadata in the digital photo file. The indexing information generated in steps 3540, 3550, 3560 and 3570 may include data that is not in the metadata for the photo, but is generated based on the metadata for the photo in conjunction with information stored in the user's U-Me account. For example, when the U-Me system recognizes a date in the photo metadata that corresponds to Jim & Pat's wedding anniversary, the U-Me system can generate indexing info for the photo that identifies the Event for the photo as Jim & Pat's Wedding Anniversary. Having dates, locations and relationships defined in the user's U-Me account provides a way to add indexing info to a photo that will help to retrieve the photo later using a powerful search engine, discussed in more detail below.

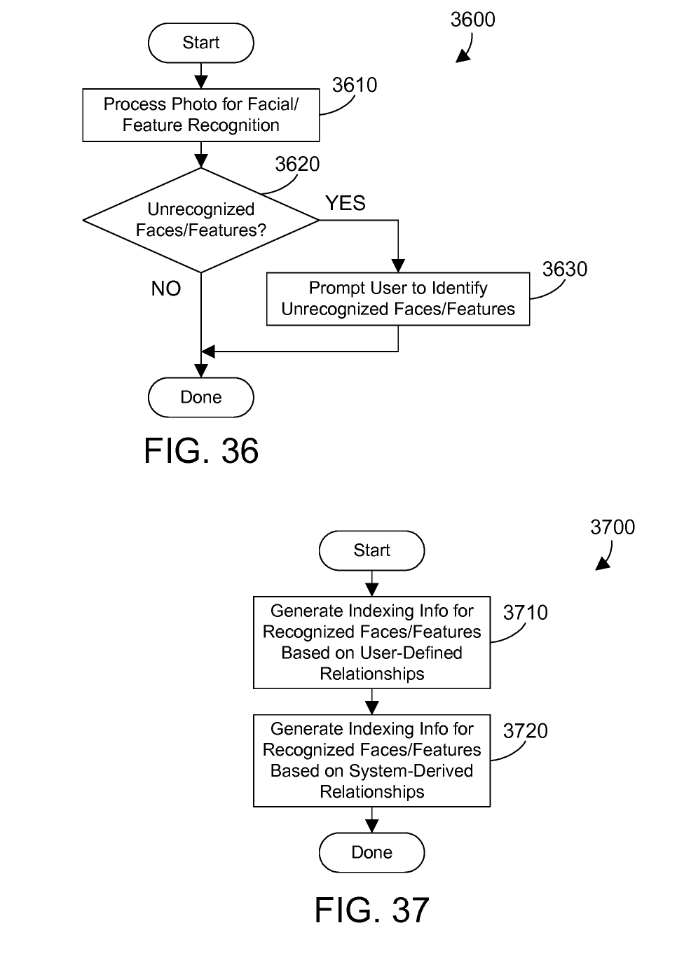

One suitable implementation for step 3530 in FIG. 35 is shown as method 3600 in FIG. 36. The photo is processed for facial and feature recognition (step 3610). Facial recognition is known in the art, but the processing in step 3610 preferably also includes feature recognition. Feature recognition may recognize any suitable feature or features in the photo that could be found in other photos. Examples of features that could be recognized include a beach, mountains, trees, buildings, a ball, a birthday cake, a swing set, a car, a boat, etc. If there are unrecognized faces or features (step 3620=YES), the user may be prompted to identify the unrecognized faces and/or features (step 3630). Method 3700 is then done.

By prompting the user for unrecognized faces and features, method 3600 gives the user the chance to build up a library of faces and features that the system will have an easier time recognizing next time around. For example, step 3630 might display the photo with various different faces and regions defined. The user could select a face and then enter the name for the person, or if the person will appear in many photos, the user could enter some or all of the person's data in a photo system data entry screen, similar to that shown in FIG. 14. The user could also select various regions of the photo to define features that could be recognized in future photos. For example, if a photo shows a couple on a beach with a cruise ship in the background, the user could click on each face to define information corresponding to those two people, and could also click on the sand on the beach and define this feature as “beach”, click on the water and define this feature as “water”, and click on the cruise ship and define this feature as “boat.” Using various heuristics, including artificial intelligence algorithms, these features may be recognized in other photos, which allows adding indexing information that describes those features automatically when the photo is processed, as shown in method 3600 in FIG. 36.

Referring to FIG. 37, a method 3700 is one specific implementation for step 3540 in FIG. 35. Indexing info is generated for recognized faces and/or features based on the user-defined relationships (step 3710). Indexing info is also generated for the recognized faces and/or features based on the system-derived relationships (step 3720).

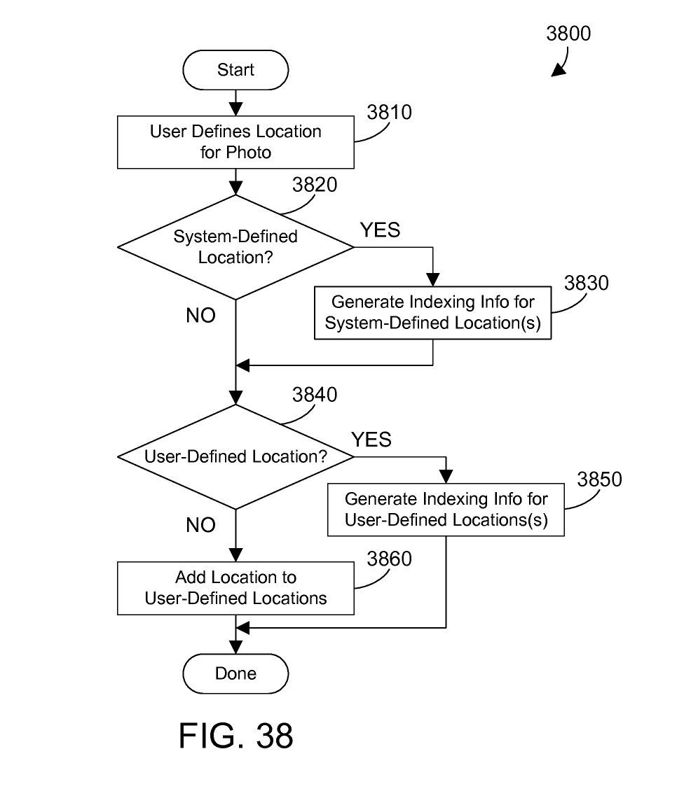

Method 3800 in FIG. 38 is one suitable implementation for step 3550 in FIG. 35 for a digital photo file that does not include any geocode info. A user defines the location for the photo (step 3810). For example, the user may specify the location using geographical coordinates, or by selecting a name of a geographical location that has already been defined by the user or by the system. This would be the logical approach when a digital photo file has been created from a hard-copy photo, and no geocode info is available for the photo. When the location corresponds to one or more system-defined locations (step 3820=YES), indexing info is generated for the system-defined location(s) (step 3830). When the location corresponds to one or more user-defined locations (step 3840=YES), indexing info is generated for the user-defined location(s) (step 3850). When the location is not a user-defined location (step 3840), the user may opt to add the location to the user-defined locations (step 3860). Note that a single photo can include indexing info that relates to multiple user-defined locations and multiple system-defined locations, all based on the one location where the photo was taken. For example, if we assume region 2810 in FIG. 28 is defined as Jim & Pat's House, and region 2820 is defined as Jim & Pat's Property to include Jim & Pat's House, and assuming the house and property are in Jasper County, Missouri, a photo taken in Jim & Pat's House could include indexing info that specifies the location as Jim & Pat's House, Jim & Pat's Property, Jasper County, Missouri, USA.

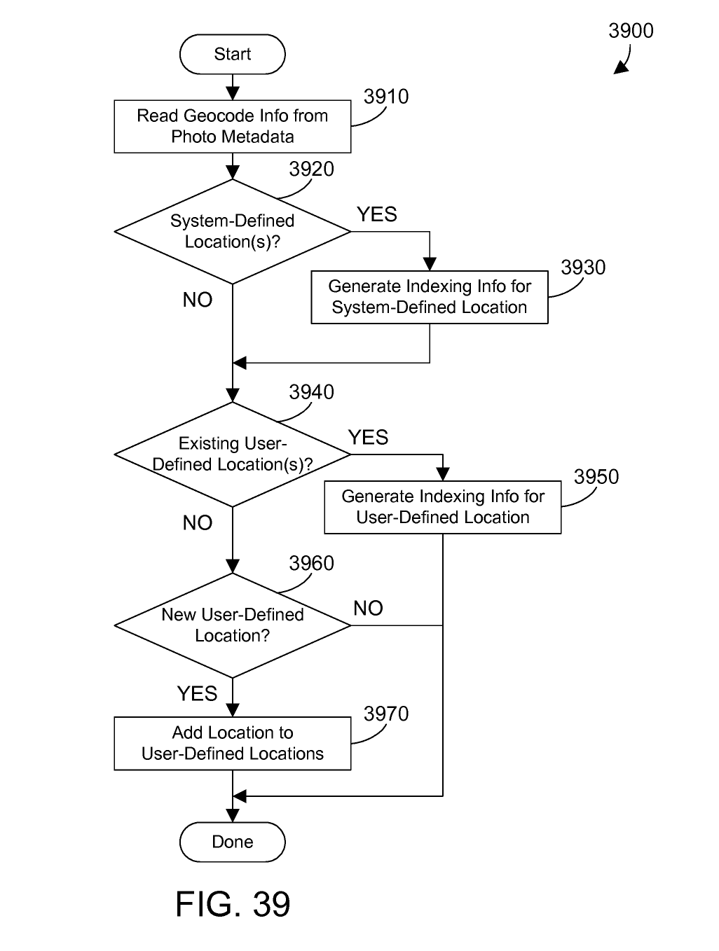

Referring to FIG. 39, a method 3900 is one suitable implementation for step 3550 in FIG. 25 for a digital photo file that includes geocode info, such as a photo taken with a smart phone. The geocode info is read from the photo metadata (step 3910). When the geocode info corresponds to one or more system-defined locations (step 3920=YES), indexing info is generated for the system-defined location (step 3930). When the geocode info corresponds to one or more existing user-defined locations (step 3940=YES), indexing info is generated for the user-defined location (step 3950). When the geocode info does not correspond to any existing user-defined locations (step 3940=NO), and when the user wants to add this location as a new user-defined location (step 3960=YES), the location is added to the user-defined locations (step 3970). Here again, indexing info for a photo can specify many different locations that all apply to the photo, both user-defined and system-defined.

The generation of location-based indexing info for photos may be done using any suitable heuristic and method. For example, if Jim Jones takes a photo of a grandson at a birthday party in his living room in his house, the U-Me system will recognize the location as Jim & Pat's House, and will store this location as indexing info with the photo. If Jim takes a photo of the grandson fishing at a pond on the property, the U-Me system will recognize the smart phone is not at the house but is on the property, and will recognize the location as “Jim & Pat's Property”, and will store this location as indexing info with the photo. In addition, various heuristics could be defined to generate location descriptors. For example, anything within 100 yards of a defined location but not at the defined location could be “near” the defined location. The disclosure and claims herein expressly extend to any suitable location information that could be generated and included as indexing information to describe location of where a photo was taken.

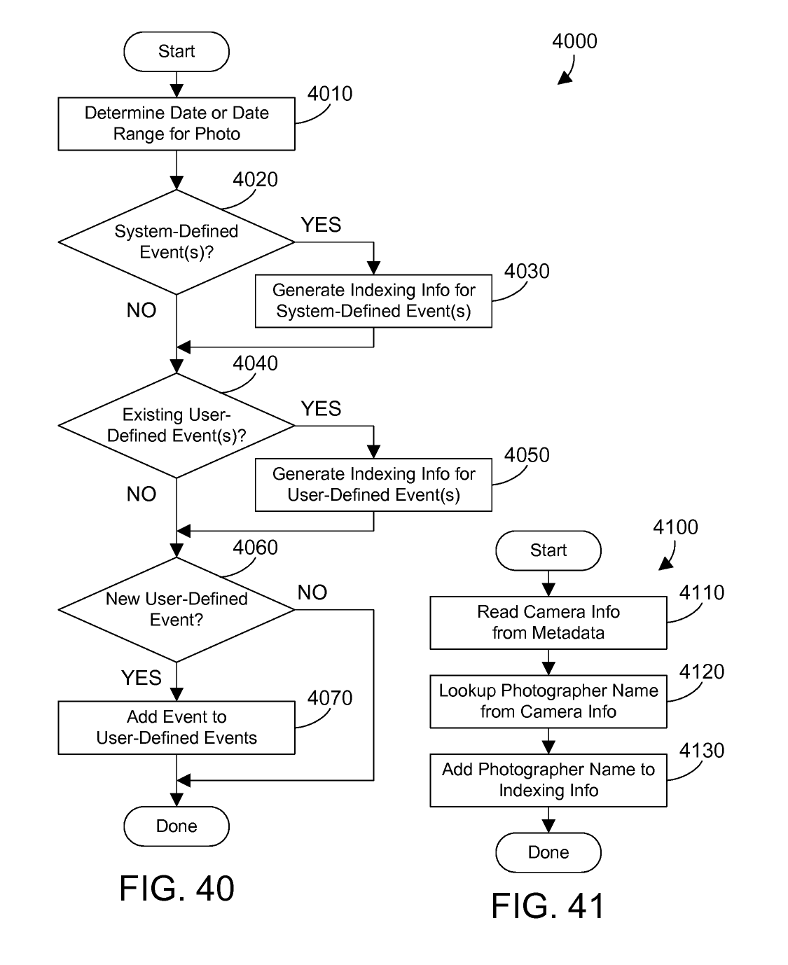

Method 4000 in FIG. 40 is one suitable implementation for step 3560 in FIG. 35. A date or date range is determined for the photo (step 4010). For the case of a digital photo file from a scanned hard copy photo that does not include a date, the user could specify a date or date range for the photo. Why would the user specify a date range instead of an exact date? One reason is when the user is not sure of the specific date the photo was taken, but can narrow it down to a date range. Another reason is a date range could apply to many photos to make it easier to generate indexing info for those photos. When the digital photo file includes a date that indicates when the photo was taken, determining the date in step 4010 will include reading the date from the metadata in the digital photo file. When the date or date range corresponds to one or more system-defined events (step 4020=YES), indexing info is generated for the corresponding system-defined events (step 4030). When a recognized person is in the photo image, step 4020 will be YES because step 4030 will be performed to compute the age of any and all recognized persons in the photo. Note that age can be computed differently for infants than for older children and adults. When asked how old a baby or a toddler is, the mother will typically reply in months because this is much more informative than telling years. The U-Me system could recognize this, and in addition to generating indexing info that indicates years for a recognized person, when that person is less than say three years old, the indexing info generated in step 4030 could additionally include the age of the recognized person in months. When the date or date range corresponds to one or more user-defined events (step 4040=YES), indexing info is generated for the corresponding user-defined event(s) (step 4050). When the date or date range does not correspond to an existing user-defined event (step 4040=NO) and the user wants to create a new user-defined event (step 4060=YES), the event is added to the user-defined events (step 4070).

One advantage to the U-Me system being person-centric is camera information can be converted to the corresponding person who took the photo. Referring to FIG. 41, a method 4100 reads camera info from the metadata for a photo (step 4110), looks up the photographer name that corresponds to the camera info (step 4120), and adds the photographer's name to the indexing info (step 4130). In this manner, the metadata in the photo that identifies the camera is used to go a step further to identify the person who uses that camera so the photographer can be specified in the indexing information for the photo. Method 4100 in FIG. 41 is one suitable implementation for step 3570 in FIG. 35.

Referring to FIG. 4200, method 4200 is a method for storing a photo with corresponding indexing information. The user takes the photo (step 4210). The U-Me software or app sends the photo with metadata (i.e., the digital photo file) to the user's U-Me account (step 4220). The U-Me software or app can send the photo with metadata to the user's U-Me account in any suitable way, including a direct connection from the U-Me software or app to the U-Me system. In the alternative, the U-Me software or app can send one or more e-mails to the user. The U-Me system monitors incoming e-mail, and when a photo is detected, embedded in an e-mail or as an attachment, the U-Me system recognizes the file as a photo. Facial and feature recognition is performed (step 4230). Indexing information is generated for all recognized faces and features (step 4240), for all recognized locations (step 4250), for all recognized events (step 4260), and for any other metadata (step 4270). The digital photo file, including its metadata, is stored with the generated indexing info in the user's photo database (step 4280). When input from the user is needed (step 4282=YES), a flag is set to prompt the user for the needed input (step 4290). Setting a flag lets the user decide when to enter the needed input. Thus, when a user has some spare time, the user may log into the U-Me account and enter all needed input that has accumulated for many photos that have been taken. Method 4200 could be carried out by a user taking a photo with a smart phone that is running the U-Me app, which results in the photo being automatically uploaded, processed, and stored in the user's U-Me account.

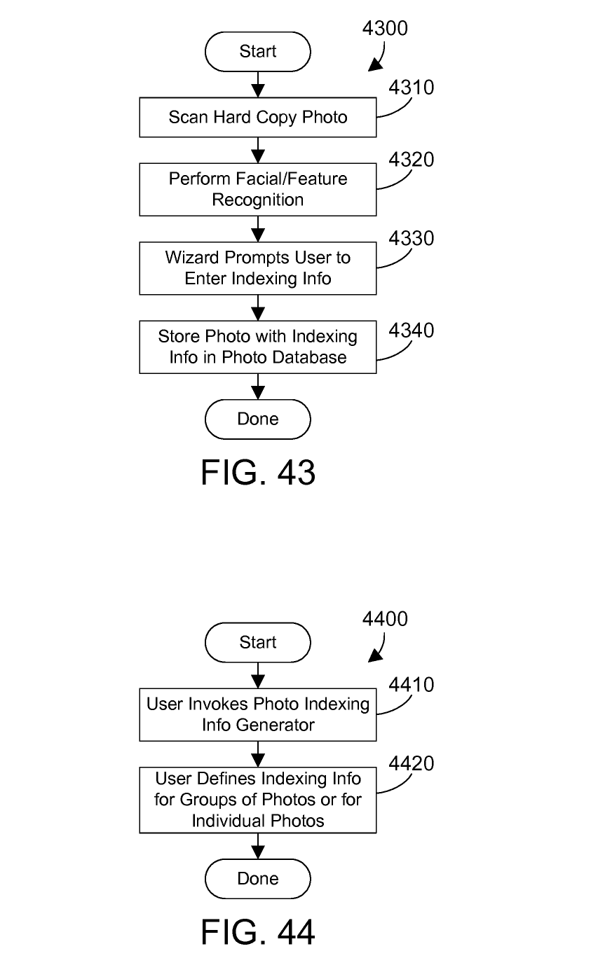

While most young adults and children have taken only digital photographs for their entire lives, older people typically have hundreds or thousands of hard copy photographs. These people need a way to store those photos electronically so they can be easily searched and retrieved as needed. Referring to FIG. 43, method 4300 begins by scanning a hard copy photo (step 4310). Facial and feature recognition is performed (step 4320). A wizard prompts the user to enter indexing information for the photo (step 4330). The photo with its indexing info is then stored in the user's photo database (step 4340). Note the indexing info can be stored in the metadata in the digital photo file, or can be stored separately from the digital photo file.

Repeating method 4300 for hundreds or thousands of individual photos may be too time-consuming. Instead, the user may process photos in groups. Referring to FIG. 44, method 4400 begins by a user invoking a photo indexing info generator (step 4410). The user can then define indexing info for groups of photos or for individual photos (step 4420).

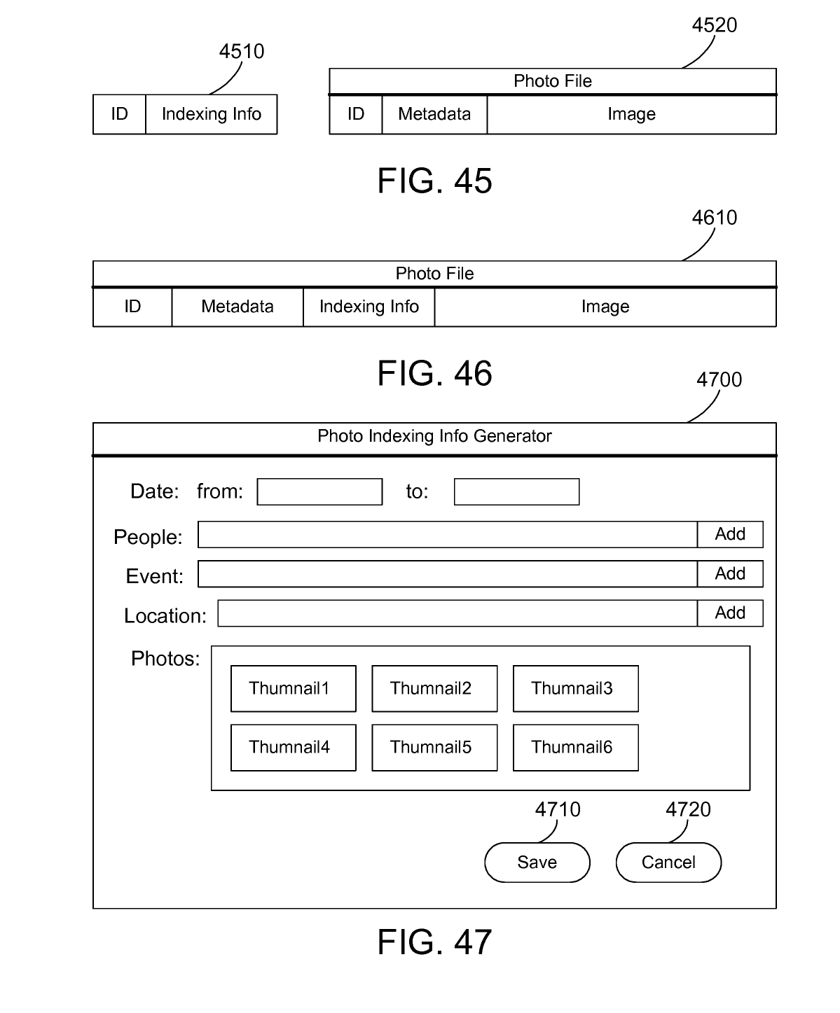

A sample digital photo file 4520 is shown in FIG. 45 to include an identifier (ID), Metadata, and the Image. While the indexing information is “metadata” in a general sense, the term “metadata” as used herein relates to data generated by the camera that describes some attribute related to the image, while “indexing info” as used herein relates to data that was not included in the metadata for the image but was generated by the U-Me system to facilitate retrieval of photos using a powerful search engine. The indexing info 4510 can be stored separately from the digital photo file 4520 by simply using the same unique identifier for the photo to correlate the indexing info to the photo. In the alternative, the indexing info can be stored as part of the digital photo file 4610, as shown in FIG. 46.

An example of a photo indexing info generator screen 4700 is shown in FIG. 47 to include Date fields, a People field, an Event field, a Location field, and a display of thumbnails of photos. The user specifies a date or range of dates in the Date fields. The user specifies one or more people in the People field. The user specifies location in the Location field. An example will illustrate how a user might use the photo indexing info generator in FIG. 47 to generate indexing info for scanned hard copy photos. Let's assume Jim Jones has a stack of 163 photos of all the wedding-related photos of when he married Pat, including some on the morning of their wedding day showing the wedding ceremony, some that were taken later on their wedding day at the reception, and some a week later at a second reception in Pat's hometown. Instead of defining indexing info for each photo, Jim could enter a date range that begins at the wedding day and extends to the date of the second reception, could define an event called “Jim & Pat's Wedding”, and could select the 163 thumbnails that correspond to the wedding and reception photos. Once this is done, the user selects the Save button 4710, which results in the photos being saved in Jim's photo database with the appropriate dates and event information as indexing information. Note the People, Event and Location fields can include drop-down lists that list people, events and locations that have been previously defined, along with a selection to define a new event or location. If the user decides to abort entering the indexing info for photos, the user may select the Cancel button 4720.

A significant advantage of generating indexing info for photos is the ability to search for and retrieve photos using the indexing info. No longer must a user search through hundreds or thousands of thumbnails stored in dozens or hundreds of directories with cryptic names that mean nothing to a person! Instead, the user can use a photo search engine to retrieve photos based on people, their ages, family relationships both entered and derived, location, dates, and events.

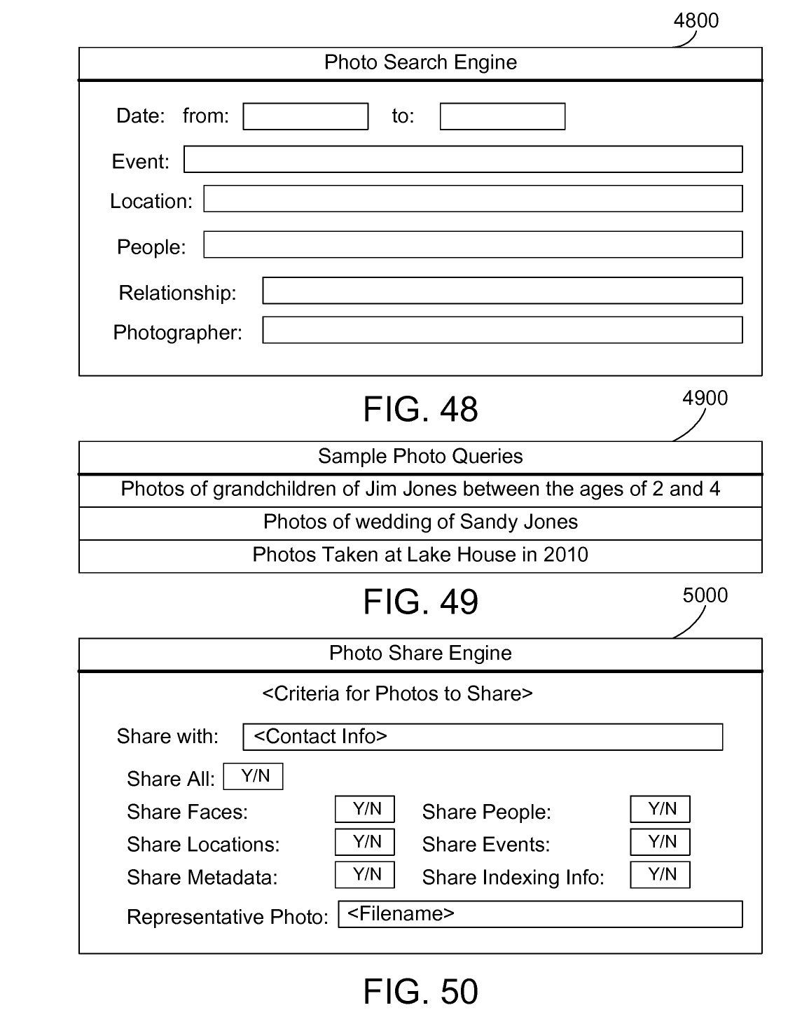

One example of a screen 4800 for a photo search engine is shown in FIG. 48. The example shown in FIG. 48 includes fields for Date(s), Event, Location, People, Relationship, and Photographer. Because of the relationships entered by the user and derived by the U-Me system, searches or queries for photos can now be formulated based on those relationships. Examples of photo queries supported by the photo search engine 4800 in FIG. 48 are shown at 4900 in FIG. 49, and include: photos of grandchildren of Jim Jones between the ages of 2 and 4; photos of the wedding of Sandy Jones; and photos taken at the Lake House in 2010. These simple examples illustrate that adding indexing info that relates to people, locations and events allows for much more powerful querying and retrieving of photos than is known in the art.

The user may want to share photos stored in the user's U-Me account. This can be done using a photo share engine, a sample display of which is shown at 5000 in FIG. 50. The photo share engine could be provided as a feature of the sharing mechanism 174 shown in FIG. 5, or could be provided by the photo mechanism 182. The user defines criteria for photos to share, then specifies contact information for people with whom the user wants to share the photos. The user can also select whether to share the user's faces, people, locations, events, metadata, and indexing info. The criteria for photos to share can include any suitable criteria, including any suitable criteria that could be entered into the photo search engine for retrieving a photo. The “Share with” field could be a drop-down list with people in the U-Me system, could be a drop-down list of people the user has defined in the user's U-Me account, or could be an e-mail address or other unique identifier for the person. A user could thus enter the e-mail address of a person who is not a U-Me member, and this could result in the U-Me system sending an e-mail to the person inviting the person to join U-Me to view the photos the user is trying to share with the person. The Representative Photo could designate a photo that includes many family members so the person invited to share the photos can see how the people in the representative photo are identified by the person sharing the photo.

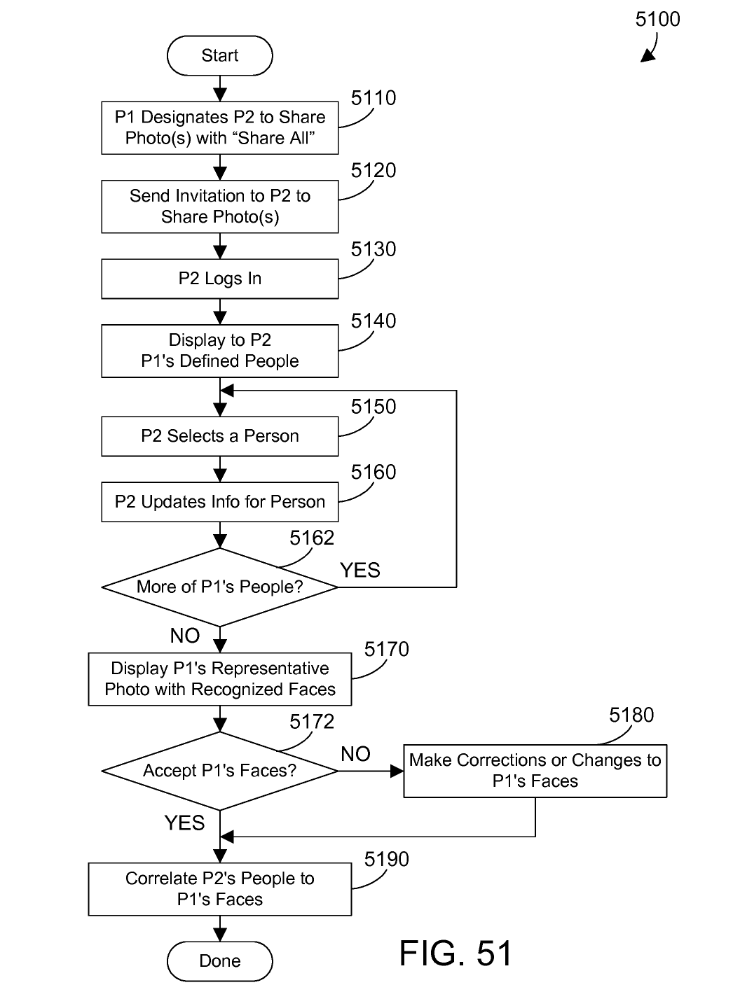

Referring to FIG. 51, a method 5100 is one example of how a U-Me user could share information with other U-Me users. For method 5100, P1 denotes a first U-Me user who wants to share photos and related information with a second U-Me user denoted P2. P1 designates P2 to share photos with the “Share All” option (step 5110). Referring to FIG. 50, selecting Yes to the Share All option causes all of the user's photo-related information to be shared with another user, including faces, people, locations, events, metadata, and indexing info. The U-Me system sends an invitation to P2 to share P1's photos (step 5120). If P2 is not yet a U-Me user, P2 will sign up as a U-Me user. P2 logs in to the U-Me system (step 5130). P1's defined people are displayed to P2 (step 5140). P2 may select one of P1's people (step 5150) and update info for that person (step 5160). In the most preferred implementation, P2 updating the info for that person does not change the info for that person in P1's account. Instead, the info for that person in P1's account is copied to P2's account so changes made by P2 do not affect the person info in P1's account. For example, let's assume Jim Jones invites his son Billy to share some family photos. Let's further assume Billy selects Fred Jones, who has a Preferred Name in Jim's account of Dad Jones. Billy calls Fred Jones Grandpa Jones, not Dad Jones. So Billy could update the Preferred Name for Fred Jones to be Grandpa Jones in step 5160. When there are more of P1's people that P2 may want to update (step 5162=YES), method 5100 loops back to step 5150 until there are no more of P1's people that P3 wants to update (step 5162=NO). P1's representative photo may be displayed to P2 showing the recognized faces (step 5170). P2 may then identify the identifies of the recognized faces in the representative photo to assure they are correct. If the user updated info for P1's people in step 5160, P2's preferred names for those people can now be displayed for the recognized faces in step 5170. When P2 accepts P1's faces (step 5172=YES), P2's people are correlated to P1's faces (step 5190). When P2 does not accept P1's faces (step 5172=NO, P2 may make any needed corrections or changes to P1's faces (step 5180) before correlating P2's people to P1's faces (step 5190).

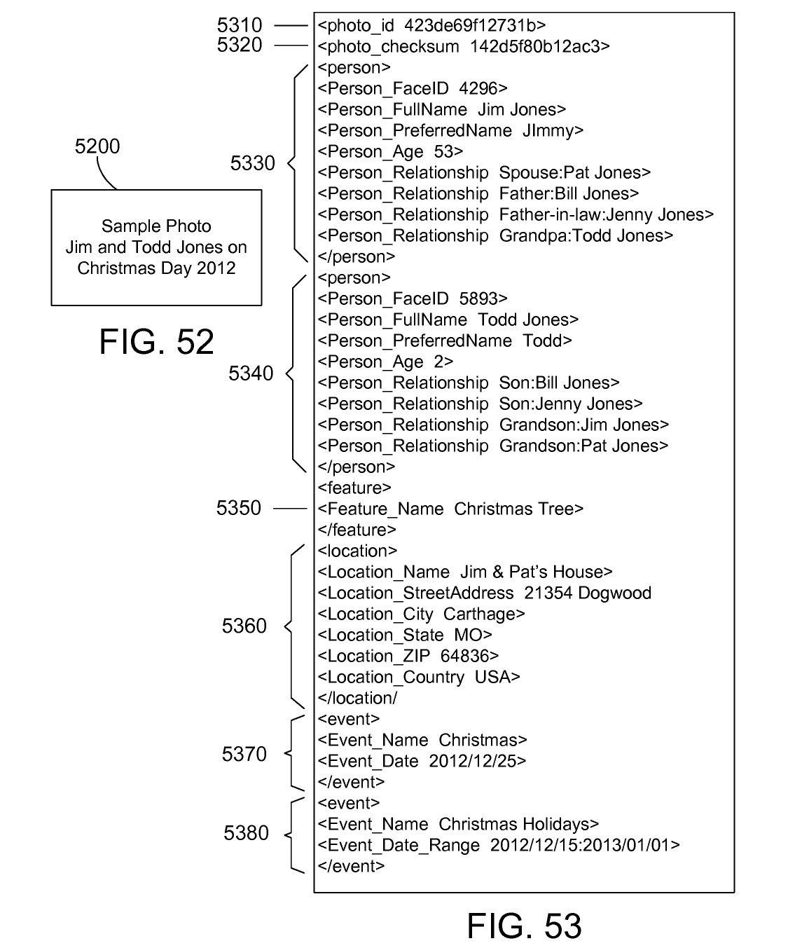

An example is now presented to illustrate the generation of indexing information for a photo by the U-Me system. Referring to FIG. 52, a sample photo 5200 is represented that includes Jim Jones and Todd Jones on Christmas Day 2012. Based on information entered by the user in the data entry screen 1610 in FIG. 17 and based further on entering additional information in Billy Jones' information that shows his wife is Jenny Black and his son is Todd Jones (as shown in FIG. 23), the indexing information shown in FIG. 53 could represent examples of possible indexing information for the photo in FIG. 52 generated by the photo mechanism in the U-Me system. The first tag at 5310 in FIG. 53 is a photo_id tag that provides a unique identifier that identifies the photo to the U-Me system. The unique identifier in tag 5310 shown in FIG. 53 is in hexadecimal format. The second tag 5320 is photo_checksum, which provides a checksum for the image that is computed based on the information in the image portion of the photo file. While the photo_checksum value could include information in the metadata and indexing info for a photo, in the most preferred implementation the photo_checksum would include only the image data in the checksum computation so changes to the metadata or the indexing info will not affect the value of the photo_checksum. Indexing info for Jim Jones is shown in the person tag at 5330. Each person may be given a unique face identifier, such as Person_FaceID shown in FIG. 53, that uniquely identified a face recognized by the facial recognition software in the U-Me system. The indexing info for Jim Jones shown at 5440 include a Person_FaceID of 4296, a Person_FullName of Jim Jones, a Person_PreferredName of Jimmy, a Person_Age of 53, and four Person_Relationship entries that specify one or more relationships in the U-Me system, including a relationship that specifies Jim Jones is the spouse of Pat Jones, is the father of Bill Jones, is the father-in-law of Jenny Jones, and is a grandpa of Todd Jones. Other person relationships could be included for Jim Jones (such as stepfather of Sally Jones), but are omitted from FIG. 53 due to space constraints. The indexing info for a person preferably includes all relationships for that person, both user-defined and system-derived. Indexing info for Todd Jones is shown in the person tag at 5340. Note the age of Todd Jones is shown as 2, and Todd's family relationships are also indicated. As stated above, Todd's age could additionally be shown in a number of months since he is a young child under some specified age, such as three.

The indexing info at 5350 is due to the facial and feature recognition engine recognizing a Christmas tree in the photo. The indexing info at 5360 includes all location info for the photo. We assume the photo was taken in Jim's house. Thus, the location information includes the name Jim & Pat's House with the address, city, state, zip and country. In an alternative implementation, a separate location tag could be created for each item that specifies a location. Indexing info 5370 and 5380 are also shown, which correspond to two defined events. Indexing info 5370 identifies the event as Christmas, and a date of 2012/12/25, while indexing info 5380 identifies the event as Christmas Holidays with a date range of 2012/12/15 to 2013/01/01. The indexing info shown in FIG. 53 is used by the U-Me system to create indexes that allow easily identifying many different pieces of information that can be used in formulating a sophisticated search. Thus, if Pat Jones does a search for photos of all her grandchildren, this photo 5200 would be returned in the search because of the tag Person_Relationship:Grandson:Pat Jones. If a Jim does a search for all photos taken during the Christmas Holidays for the years 2008-2012, this picture will also be returned in the search because of the tag that defines the event as Christmas Holidays for the specified date range. If Pat does a search for all photos of Todd taken at Jim & Pat's house, this photo would also be returned. If Jim does a search for all photos that include grandchildren when Jim's age is over 50, this photo will also be returned in the search. One skilled in the art will readily recognized that all of the information shown in FIG. 53 can be used in a database search engine to formulate complex and sophisticated queries for a user's photos.

The term “tag” used with respect to the indexing info is a different kind of “tag” known in the art for tagging photos. This potential confusion is caused by the use of the label “tag” for two different things in the art. A tag in the indexing info described herein could be a markup language tag that identifies some attribute of the photo. Known tags for photos, in contrast, are simple labels. Thus, a user can use Google's Picasa software and service to perform facial recognition on photos and to tag photos with the names of the recognized people. These simple tags are labels that are searchable, but do not contain any relationship information, ages of people in the photos, events, etc. For example, if Jim Jones took the time to use Google's Picasa to tag his photos, he could enter a tag such as Billy on all the photos that include his son Billy. But the tag Billy is a simple text tag, a mere label. While searchable, known photo tags do not provide the flexibility and power of the U-Me system. Known tags are photo-centric, while indexing info generated by the U-Me system is person-centric. With known photo tags, a person cannot do powerful searches looking for grandchildren, looking for people of a particular age, etc. In addition, if Jim were to tag the sample photo 5200 in FIG. 52 with the tag “Christmas 2012”, that is a complete label and not subject to parsing. Thus, there is no way to search for all Christmas photos, and have that search return the photo that is tagged with “Christmas 2012.” The user would have to specify Christmas 2012 in order for the tag to match the search term. This shows how woefully inadequate known photo tagging is, and how the U-Me photo mechanism provides a significant improvement by generating person-centric indexing info that includes both user-defined information as well as system-derived information that is derived from the user-defined information.

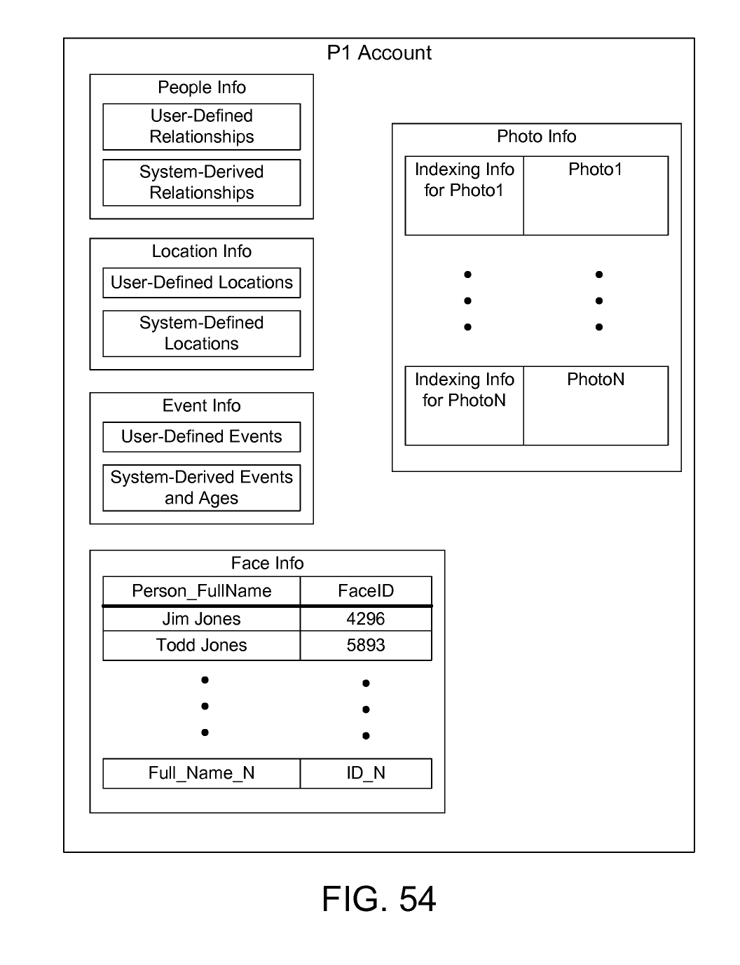

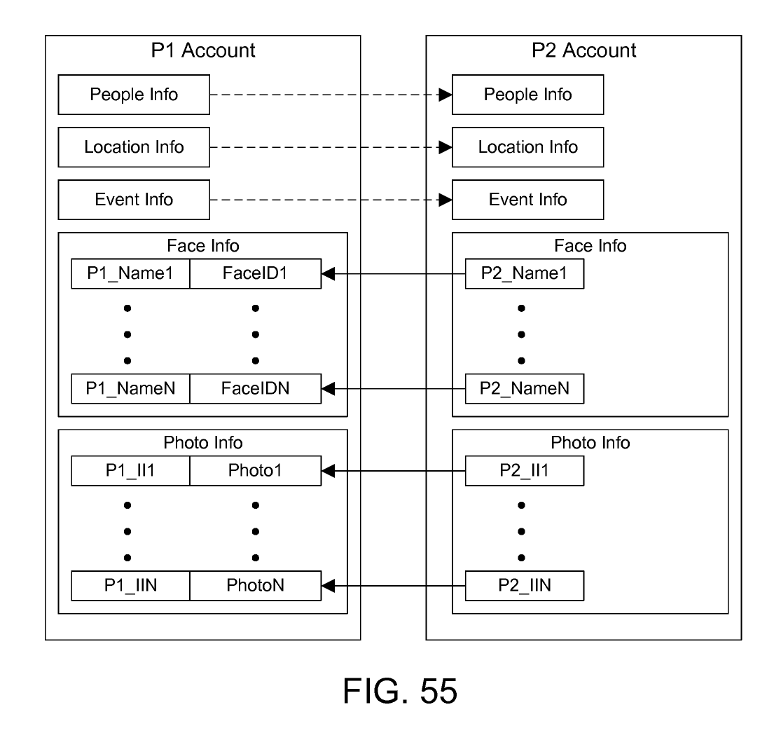

FIGS. 54 and 55 illustrate how a first user called P1 can share photo-related information with another user called P2. Features of P1's U-Me account related to the photo mechanism are shown in FIG. 54 to include People Info, Location Info, Event Info, Face Info, and Photo Info, which is a database of P1's photos that includes photos and associated indexing info. Note the indexing info could be stored separate from the digital photo file as shown in FIG. 45, or could be stored as part of the digital photo file as shown in FIG. 46. We now assume P1 wants to share all of P1's photos with P2, as shown in method 5100 in FIG. 51. Because P1 selected “Share All” when sharing P1's photos with P2, when P2 creates P2's U-Me account, all of the People Info, Location Info, and Event Info are copied to P2's account, as shown by the dotted lines in FIG. 55. Once the info has been copied, it can be edited by P2 in any suitable way. For example, let's assume Jim Jones enters a preferred name of Cookie for his wife Pat because that is the nickname he always uses to refer to Pat. If Jim shares his photo info with his son Bill, it is likely that Bill will want to change the preferred name of Cookie for Pat to something else, like Mom. In addition, if Jim defined a location for Jim & Pat's House and Jim & Pat's Property as illustrated in FIG. 28, Bill could change the location name to Mom & Dad's House and Mom & Dad's Property. P2 could thus use the copied definitions for People Info, Location Info and Event Info from P1's account as a shortcut to defining people, locations and events in P2's account.

When face information is shared, the names of the recognized faces are copied from P1's account to P2's account. However, P2 may want to name the people in the photos differently than P1. As a result, P2's account can have names for the recognized faces that are different than the names P1 uses. Thus, the face info in P2's account could include names that point to face IDs in P1's account. This provides a significant advantage. Facial recognition software recognizes faces, and the processing time may increase with an increase in the number of recognized faces. P2 gets a shortcut because the U-Me photo mechanism has already done facial recognition on P1's photos and has generated indexing info for those faces. By pointing people in P2's account to faces recognized in P1's account, the number of faces in the facial recognition database does not double by adding P2. This can also be a significant issue because some facial recognition software is licensed based on the number of templates (faces) in the facial recognition database. By sharing face info between users as shown in FIG. 55, the U-Me system both benefits from earlier work done for one user and also avoids an unneeded increase in the number of faces in the facial recognition database. In addition, when P2 adds more photos of people who have already been recognized, the facial recognition for that person can improve for P1 as well. Sharing face info thus provides benefits to both the sharing party and the party to whom the face info has been shared.

The sharing of photos between P1 and P2 is done in a way similar to the sharing of face info. In the most preferred implementation, the photos remain in P1's account, and are not copied to P2's account. Instead, P2's account includes photo info that is indexing info for the photos that can be separate from the digital photo files. Thus, P1's account has photos Photo1, . . . , PhotoN and corresponding indexing info for P1, labeled P1_II1, . . . , P1_IIN. When P2's account is created to share P1's photos, the indexing info can be copies to P2's account, and the indexing info can then be modified as desired by P2. The result is P2 having its own set of indexing info P2_II1, . . . , P2_IIN for the photos stored in P1's account. The U-Me system thus allows users to share photos and related information in a very efficient manner while still providing customization for each user, and while providing an incredibly powerful search engine that can retrieve photos based on relationships, locations and events.

The U-Me photo mechanism may include a way for a person such as P2 in FIG. 55 to decide to share some of P1's photos but not all. For example, a woman P1 might take seventy photos of P1's daughter at her birthday party, and may share all seventy of those photos with her mom P2. Her mom may not want or need to share all seventy of those photos. The U-Me photo mechanism could display thumbnails for P1's photos, then allow P2 to select which of those P2 wants to share. This could become an issue regarding how a user is billed for using the U-Me system. For example, let's assume a user pays a monthly subscription for access to the U-Me system, and the price depends on the amount of storage the person uses to store his or her photos. Let's further assume that when person P2 accepts to share P1's photos, the size of P1's photos is allotted against the amount of storage in P2's account. By providing a way to select which photos P2 wants out of all the photos P1 is willing to share, P2 maintains control of P2's subscription to a price desired by P2. Thus, P2 could decide to share only a small fraction of the photos offered by P1, thereby giving P2 full access to those photos, while restricting access to the other photos P1 offered to share with P2 until P2 accepts to share those other photos as well.

The sharing of photos and related information as shown above is especially valuable in the context of families. Thus, let's assume Pat Jones decides to become a U-Me subscriber, takes the time to enter all the information for the people in her family, including birth dates, wedding dates, events, locations, etc. and has the U-Me system generate the indexing info for all of her photos. This significant amount of work can be to the benefit of other users who Pat invites to share her photos, such as her husband and her children. While some of the preferred names may change, the vast majority of information entered by Pat will apply to her children and spouse as well. This allows one enthused family member to do the majority of the work in defining people and relationships in the U-Me system, and creates an incredibly powerful shortcut for others that are invited to share that family member's photos and related info.

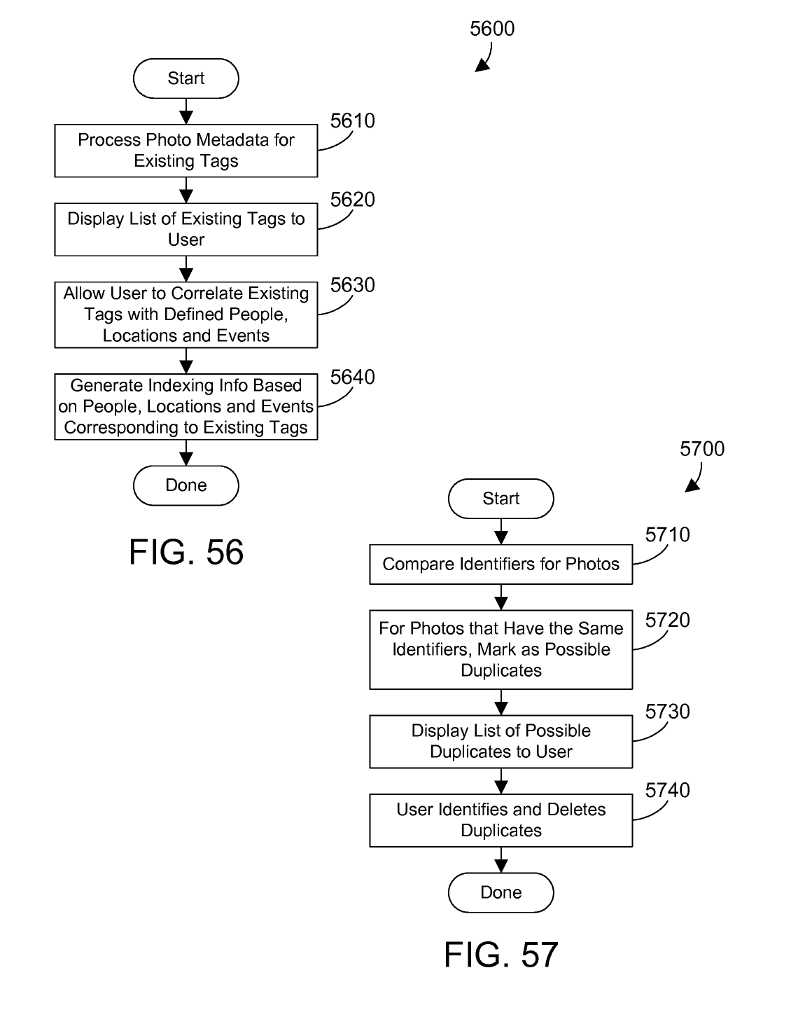

Some people have already invested a lot of time and effort to tag their photos with known photo tagging tools or software. The U-Me system can leverage this investment of time, as shown in method 5600 in FIG. 56. Method 5600 assumes the existing tags are stored as part of the photo metadata in a digital photo file. The photo metadata is processed for existing tags (step 5610). A list of existing tags is displayed to the user (step 5620). The user is then allowed to correlate existing tags with defined people, locations and events in the user's U-Me account (step 5630). Indexing info is then generated based on the people, locations and events corresponding to the existing tags (step 5640). We see from method 5600 that a user who has taken the time to perform prior art photo tagging on their digital photo files will have an advantage when importing these photos into their U-Me account, because the tags may be used to correlate photos to people, locations and events defined in the user's U-Me account.

One problem that most users of digital cameras have is duplicate photos in different locations. For example, a person might take some photos on a blank SD card and then download those photos to a computer. The user may re-insert the card into the camera, and take more photos without deleting the first set of photos. When the user downloads the photos, the user may then create a new directory and download both the first set of photos on the SD card that had been previously downloaded, along with the second set of photos on the SD card that were added later. The result is the first set of photos now exists in two different directories on the user's computer system. With dozens or hundreds of directories, many users have many duplicate photos. The U-Me photo mechanism can detect duplicate photos as shown in method 5700 in FIG. 57. Identifiers for the photos are compared (step 5710). One suitable example for identifiers that could be used to compare photos is a checksum that is computed over all the data in the image portion of a digital photo file. When two checksums match, it is very, very likely the photos are duplicates. Photos that have the same identifiers are marked as possible duplicates (step 5720). A list of possible duplicates is then displayed to the user (step 5730). The user can then identify duplicates from the list and delete any duplicates (step 5740). By detecting and deleting duplicates as shown in method 5700, the U-Me photo mechanism avoids needless storage and processing of duplicate photos.

Because the U-Me system is people-centric, and uses relationships between people such as family relationships in generating indexing information, the U-Me system is ideal for genealogists to use for photos of their family members. The U-Me photo mechanism thus includes the capability of importing a file that specifies people and relationships (step 5810), such as a .GEDCOM file generated by most popular genealogy software, such as Roots Magic. Photo system data is generated in the user's U-Me account for the people in the imported file (step 5820). System-derived relationships are then derived based on the relationships in the imported file (step 5830). A genealogy file such as a .GEDCOM file can thus provide a significant shortcut for importing data regarding people and family relationships into a user's U-Me account. Note the file need not necessarily be a genealogy file, but could be any type of file that represents people and/or relationships between people, such as an organization chart for a business.

One problem with prior art photo tags is they are static. Once defined, they don't change. If a user wants to add more tags to a photo, the user must add the tag manually. A significant advantage of the U-Me system is the ability to dynamically update indexing info for a person when information is added or changed. For example, let's assume the photo mechanism recognizes a person's face in 49 photos, but the user has not yet correlated the face to a defined person. The face is represented by a face ID, as shown by way of example in FIG. 53. Once the face is correlated by the user to a defined person, the attributes for that person may by dynamically added to the indexing info. Thus, if the facial recognition software recognized the face of Todd Jones and identified it a FaceID of 5893, but this face had not yet been correlated to the personal info for Todd Jones, this FaceID would be the only information in the person tag 5340 in FIG. 53. Once the user correlates Todd's face to Todd's personal info in the user's U-Me account, all of the pertinent info relating to Todd can be added to the photo dynamically without any input required from the user. Thus, the mere act of identifying the face in photo 5200 to be the face of Todd Jones that is defined in the user's U-Me account, the additional information will be added to the indexing info automatically.

Referring to FIG. 59, a method 5900 illustrates how additions or changes are automatically propagated to indexing info for a user's photos. An addition or change to a person's people, relationships, locations or events is detected (step 5910). This change is then propagated to the indexing info for all affected photos (step 5920). A simple example will illustrate. Let's assume Bill and Jenny Jones have a daughter named Polly three years after having Todd. Once Polly's information is entered into the U-Me system, the indexing info for each photo that has any person related to Polly will be updated to reflect that person's relationship to Polly. For example, upon saving the personal information for Polly, the tag 5330 in FIG. 53 would be updated to add a field Person_Relationship=Grandpa:Polly Jones and the tag 5340 would be updated to add a field Person_Relationship=Brother:Polly Jones. In another example, let's assume Jim & Pat occasionally spend Christmas at a cabin in the mountains that they rent. The owners offer to sale the cabin to Jim & Pat, who accept and purchase the cabin. When a location is defined for “Our Cabin”, all pictures that include the geographic information for the cabin will be updated to include the location name “Our Cabin.” These examples show that data can essentially lie dormant in a photo for a long time. But once information is added or changed in the user's U-Me account, this information can be updated to reflect the added or changed information. Note the addition or change of information could be selectively controlled to apply to some photos and not to others. In the example above, let's assume Jim & Pat define a location called “Rental Cabin” for the cabin during the years they rented the cabin, then define the same location as “Our Cabin” for the years after the purchase. The purchase date could be entered, and all photos prior to the purchase date could have the location name “Rental Cabin” while all photos after the purchase date could have the location name “Our Cabin.” Of course, the U-Me system could recognize the physical location is the same, yet maintain different indexing info for different photos based on date.

The people-centric nature of the U-Me system lends itself to some great features for the photo mechanism. For example, creating a person in a user's U-Me account can result in automatically creating a “container” corresponding to that person in the user's U-Me account. The user can select any container corresponding to any person, which will result in displaying or listing all photos that person is in. Note the containers do not “contain” the photos in a literal sense, but contain pointers to the photos stored in the user's photo database. Note the displayed photos for a person can be organized in any suitable way, such as chronologically, alphabetically according to location, etc.

As is clear from the detailed discussion above, the U-Me system provides A computer-implemented method executing on at least one processor comprising: defining user-defined information for a plurality of people including at least one user-defined relationship between the plurality of people and at least one user-defined event for a person that comprises at least one of a birth date and a wedding date; deriving at least one system-derived relationship between the plurality of people that is derived from the at least one user-defined relationship; processing a digital photo file that includes a date and geocode information that indicates where the digital photo file was generated; identifying a person in an image in the digital photo file by performing facial recognition that recognizes a face in the image and allows a user to correlate the recognized face to one of the plurality of people; generating at least one system-derived event for the identified person that is derived from the at least one user-defined event, the at least one system-derived event comprising at least one of: an age of the person computed from the date in the digital photo file and the birth date of the person; a birthday of the person computed from the date in the digital photo file and the birth date of the person; and an anniversary of the person computed from the date of the digital photo file and the wedding date of the person; generating a location for the photo, where the location comprises at least one of a user-defined location derived from the geocode information in the digital photo file and a system-defined location derived from the geocode information in the digital photo file; generating indexing information for the digital photo file that includes the one of the plurality of people corresponding to the recognized face, at least one user-defined relationship between the one of the plurality of people and at least one other person, at least one system-derived relationship between the one of the plurality of people and at least one other person, at least one system-derived event for the one of the plurality of people, and location for the photo; and storing the indexing information for the digital photo file.

The specification herein uses different terms for phones, including cell phones, smart phones, and just “phones.” These are all examples of different mobile phones. The disclosure and claims herein expressly extend to any and all mobile phones, whether currently known or developed in the future.

The specification herein discusses different types of computing devices, including smart phones, tablets, laptop computers, and desktop computers. The term “computer system” as used herein can extend to any or all of these devices, as well as other devices, whether currently known or developed in the future. In one specific context, a computer system is a laptop or desktop computer system, which is a different type than a phone or a tablet.

The disclosure herein uses some shortened terms for the sake of simplicity. For example, the word “information” is shortened in many instances to “info”, the word “photograph” is shortened in many instances to “photo”, and the word “specifications” is shortened in some instances to “specs.” Other shortened or colloquial terms may appear in the specification and drawings, which will be understood by those of ordinary skill in the art.

Many trademarks and service marks have been referenced in this patent application. Applicant has filed US federal service mark applications for “Universal Me” and for “U-Me”. All other trademarks and service marks herein are the property of their respective owners, and applicant claims no rights in these other marks.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A computer system comprising:
at least one processor;
a memory coupled to the at least one processor;
information for a plurality of people including at least one user-defined relationship between the plurality of people;
at least one system-derived relationship between the plurality of people that is derived from the at least one user-defined relationship; and
a photo mechanism residing in the memory and executed by the at least one processor, the photo mechanism generating indexing information for a digital photo file that includes at least one of the at least one user-defined relationship and the at least one system-derived relationship.

2. The computer system of claim 1 wherein the photo mechanism further generates an event in the indexing information for the digital photo file, where the event comprises at least one of:
at least one user-defined event; and
at least one system-derived event that is derived from the at least one user-defined event.

3. The computer system of claim 2 wherein the at least one user-defined event comprises a birth date of a person and the at least one system-derived event comprises an age of the person computed from a date for the digital photo file and the birth date of the person.

4. The computer system of claim 3 wherein the at least one system-derived event comprises a birthday of the person.

5. The computer system of claim 1 wherein the at least one user-defined event comprises a wedding date of a person and the at least one system-derived event comprises an anniversary of the person computed from a date for the digital photo file and the wedding date of the person.

6. The computer system of claim 1 wherein the photo mechanism further generates a location in the indexing information for the photo, where the location comprises at least one of a user-defined location and a system-defined location.

7. The computer system of claim 1 wherein the photo mechanism includes a facial recognition mechanism that recognizes at least one face in an image in the digital photo file and allows a user to correlate the recognized face to one of the plurality of people.

8. The computer system of claim 1 wherein the indexing information is stored separate from the digital photo file.

9. The computer system of claim 1 wherein the photo mechanism allows a user to add new people, to modify at least one of the plurality of people, and to modify the at least one user-defined relationship, and in response, the photo mechanism updates the indexing information for a plurality of digital photo files to reflect the addition or modification by the user.

10. A computer-implemented method executing on at least one processor comprising:
defining information for a plurality of people including at least one user-defined relationship between the plurality of people;
deriving at least one system-derived relationship between the plurality of people that is derived from the at least one user-defined relationship; and
generating indexing information for a digital photo file that includes at least one of the at least one user-defined relationship and the at least one system-derived relationship.

11. The method of claim 10 further comprising:
generating an event in the indexing information for the digital photo file, where the event comprises at least one of:
at least one user-defined event; and
at least one system-derived event that is derived from the at least one user-defined event.

12. The method of claim 11 wherein the at least one user-defined event comprises a birth date of a person and the at least one system-derived event comprises an age of the person computed from a date of the digital photo file and the birth date of the person.

13. The method of claim 12 wherein the at least one system-derived event comprises a birthday of the person.

14. The method of claim 10 wherein the at least one user-defined event comprises a wedding date of a person and the at least one system-derived event comprises an anniversary of the person computed from a date for the digital photo file and the wedding date of the person.

15. The method of claim 10 further comprising generating a location in the indexing information for the photo, where the location comprises at least one of a user-defined location and a system-defined location.

16. The method of claim 10 further comprising performing facial recognition that recognizes at least one face in the photo and allows a user to correlate the recognized face to one of the plurality of people.

17. The method of claim 10 further comprising storing the indexing information separate from the digital photo file.

18. The method of claim 10 further comprising detecting when a user to adds new people, modifies at least one of the plurality of people, and modifies the at least one user-defined relationship, and in response, updating the indexing information for a plurality of digital photo files to reflect the detected addition or modification by the user.

19. A computer-implemented method executing on at least one processor comprising:
defining user-defined information for a plurality of people including at least one user-defined relationship between the plurality of people and at least one user-defined event for a person that comprises at least one of a birth date and a wedding date;
deriving at least one system-derived relationship between the plurality of people that is derived from the at least one user-defined relationship;
processing a digital photo file that includes a date and geocode information that indicates where the digital photo file was generated;
identifying a person in an image in the digital photo file by performing facial recognition that recognizes a face in the image and allows a user to correlate the recognized face to one of the plurality of people;
generating at least one system-derived event for the identified person that is derived from the at least one user-defined event, the at least one system-derived event comprising at least one of:
an age of the person computed from the date in the digital photo file and the birth date of the person;
a birthday of the person computed from the date in the digital photo file and the birth date of the person; and
an anniversary of the person computed from the date of the digital photo file and the wedding date of the person;
generating a location for the photo, where the location comprises at least one of a user-defined location derived from the geocode information in the digital photo file and a system-defined location derived from the geocode information in the digital photo file;
generating indexing information for the digital photo file that includes the one of the plurality of people corresponding to the recognized face, at least one user-defined relationship between the one of the plurality of people and at least one other person, at least one system-derived relationship between the one of the plurality of people and at least one other person, at least one system-derived event for the one of the plurality of people, and location for the photo;
storing the indexing information for the digital photo file;
detecting when a user to adds new people, modifies at least one of the plurality of people, and modifies the at least one user-defined relationship; and
updating the indexing information for a plurality of digital photo files to reflect the detected addition or modification by the user.

20. The method of claim 19 wherein storing the indexing information for the digital photo file comprises storing the indexing information separate from the digital photo file.
